(19) United States
(12) Patent Application Publication
(10) Pub. No.: US 2025/0255205 A1
(43) Pub. Date: Aug. 14, 2025

(54) DRIVING CONTROL SYSTEM, WORK VEHICLE, AND DRIVING CONTROL METHOD

(71) Applicant: Kubota Corporation, Osaka (JP)

(72) Inventors: Mitsuaki NAGAO, Sakai-shi (JP); Yuma ARAKAWA, Sakai-shi (JP)

(21) Appl. No.: 19/196,723

(22) Filed: May 1, 2025

Related U.S. Application Data
(63) Continuation of application No. PCT/JP2023/038115, filed on Oct. 23, 2023.

(30) Foreign Application Priority Data
Nov. 2, 2022 (JP) 2022-176120
Nov. 2, 2022 (JP) 2022-176121

(51) Int. Cl. A01B 69/00; A01B 69/04; G06V 10/25; G06V 10/44; G06V 10/75; G06V 20/10; G06V 20/56

(52) U.S. Cl. CPC A01B 69/001; A01B 69/008; G06V 10/25; G06V 10/44; G06V 10/751; G06V 20/188; G06V 20/56

(57) ABSTRACT

A travel control system includes a processor configured or programmed to acquire first time-series images including a first portion of a crop row or a ridge from a first imager facing in a first direction, acquire second time-series images including a second portion of the crop row or the ridge from a second imager facing in a second direction, and execute image processing on the first and second time-series images to determine a travel path, and a controller configured or programmed to control travel based on the travel path. The processor is configured or programmed to find a first fitted line of the first portion in a vehicle coordinate system, based on the first time-series images, find a second fitted line of the second portion in the vehicle coordinate system, based on the second time-series images, and determine the travel path based on the first and second fitted lines.

### CROSS REFERENCE TO RELATED APPLICATIONS

This application claims the benefit of priority to Japanese Patent Application Nos. 2022-176121 and 2022-176120 filed on Nov. 2, 2022 and is a Continuation Application of PCT Application No. PCT/JP2023/038115 filed on Oct. 23, 2023. The entire contents of each application are hereby incorporated herein by reference.

### BACKGROUND OF THE INVENTION

### 1. Field of the Invention

The present invention relates to travel control systems, work vehicles, and travel control methods.

### 2. Description of the Related Art

Research and development has been directed to the automation of work vehicles, such as tractors, to be used in fields. For example, work vehicles have been put to practical use and may travel via automatic steering by utilizing a positioning system capable of precise positioning, e.g., GNSS (Global Navigation Satellite System). Work vehicles that automatically perform speed control as well as automatic steering have also been put to practical use.

Moreover, vision guidance systems are being developed which detect rows of crops (crop rows) or ridges in a field by using an imager such as a camera, and control the travel of a work vehicle along the detected crop rows or ridges.

Japanese Laid-Open Patent Publication No. 2016-208871 discloses an implement that travels along a ridge in cultivated land where crops are planted in ridges which are formed in rows. Japanese Laid-Open Patent Publication No. 2016-208871 describes binarizing a raw image acquired by capturing an image of the cultivated land from obliquely above with an onboard camera, and thereafter generating a planar perspective projection image. With the technique disclosed by Japanese Laid-Open Patent Publication No. 2016-208871, the planar perspective projection image is rotated to generate a large number of rotated images having different orientations from each other and thus to detect a work path between the ridges.

### SUMMARY OF THE INVENTION

There may be a field where curved crop rows or ridges are formed. It is required to control the travel of the work vehicle along the crop rows or the ridges even in such a field.

A travel control system according to an example embodiment of the present disclosure includes a processor configured or programmed to acquire first time-series images including a first portion of a crop row or a ridge in a field from a first imager attached to a work vehicle for agriculture so as to face in a first direction, acquire second time-series images including a second portion of the crop row or the ridge from a second imager attached to the work vehicle so as to face in a second direction different from the first direction, and execute image processing on the first time-series images and the second time-series images to determine a travel path of the work vehicle, and a controller configured or programmed to control travel of the work vehicle based on the travel path, wherein the processor is configured or programmed to find a first fitted line of the first portion in a vehicle coordinate system fixed to the work vehicle, based on the first time-series images, find a second fitted line of the second portion in the vehicle coordinate system, based on the second time-series images, and determine the travel path based on the first fitted line and the second fitted line.

A work vehicle according to an example embodiment of the present disclosure includes a first imager, a second imager, and the above-described travel control system.

A travel control method according to an example embodiment of the present disclosure is a travel control method for a work vehicle to be implemented by a computer. The travel control method causes a computer to execute acquiring first time-series images including a first portion of a crop row or a ridge in a field from a first imager attached to a work vehicle for agriculture so as to face in a first direction, acquiring second time-series images including a second portion of the crop row or the ridge from a second imager attached to the work vehicle so as to face in a second direction different from the first direction, and finding a first fitted line of the first portion in a vehicle coordinate system fixed to the work vehicle, based on the first time-series images, finding a second fitted line of the second portion in the vehicle coordinate system, based on the second time-series images, and determining a travel path of the work vehicle based on the first fitted line and the second fitted line.

A travel control system according to another example embodiment of the present disclosure includes a processor configured or programmed to acquire first time-series images including a first portion of a crop row or a ridge in a field from a first imager attached to a work vehicle for agriculture so as to face in a first direction, acquire second time-series images including a second portion of the crop row or the ridge from a second imager attached to the work vehicle so as to face in a second direction different from the first direction, and execute image processing on the first time-series images and the second time-series images to determine a travel path of the work vehicle, and a controller configured or programmed to travel of the work vehicle based on an output from the processor. The processor is configured or programmed to find a first fitted line of the first portion in a vehicle coordinate system fixed to the work vehicle, based on the first time-series images, and find a second fitted line of the second portion in the vehicle coordinate system, based on the second time-series images. The controller is configured or programmed to control the travel path of the work vehicle based on a first distance, on the vehicle coordinate system, from a front reference point on the work vehicle to the first fitted line and a second distance, on the vehicle coordinate system, from a rear reference point on the work vehicle to the second fitted line.

A work vehicle according to still another example embodiment of the present disclosure includes a first imager, a second imager, and the above-described travel control system.

A travel control method according to an example embodiment of the present disclosure is a travel control method for a work vehicle to be implemented by a computer. The travel control method causes a computer to execute acquiring first time-series images including a first portion of a crop row or a ridge in a field from a first imager attached to a work vehicle for agriculture so as to face in a first direction, acquiring second time-series images including a second portion of the crop row or the ridge from a second imager attached to the work vehicle so as to face in a second direction different from the first direction, and finding a first fitted line of the first portion in a vehicle coordinate system fixed to the work vehicle, based on the first time-series images, finding a second fitted line of the second portion in the vehicle coordinate system, based on the second time-series images, and controlling travel of the work vehicle based on a first distance, on the vehicle coordinate system, from a front reference point on the work vehicle to the first fitted line and a second distance, on the vehicle coordinate system, from a rear reference point on the work vehicle to the second fitted line.

Example embodiments of the present disclosure may be implemented using devices, systems, methods, integrated circuits, computer programs, non-transitory computer-readable storage media, or any combination thereof. The computer-readable storage media may be inclusive of a volatile storage medium, or a non-volatile storage medium. Each of the devices may include a plurality of devices. In the case where one of the devices includes two or more devices, the two or more devices may be disposed within a single apparatus, or divided over two or more separate apparatuses.

According to example embodiments of the present disclosure, even in a field including curved crop rows or ridges, it is possible to control the travel of the work vehicle along the crop rows or ridges.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 schematically shows how two imagers attached to an agricultural machine capture images of the ground surface.

FIG. 2 is a perspective view schematically showing the relationship among a body coordinate system and a camera coordinate system that are fixed to the agricultural machine and a world coordinate system that is fixed to the ground surface.

FIG. 3 is a plan view schematically showing a portion of a field where a plurality of crop rows are provided on the ground surface.

FIG. 4 schematically shows an example of image frontward of the agricultural machine shown in FIG. 3 acquired by a first imager thereof.

FIG. 5 is a plan view schematically showing a state where the forward traveling direction for the agricultural machine is inclined with respect to the direction in which the crop rows extend.

FIG. 6 schematically shows an example of image frontward of the agricultural machine shown in FIG. 5 acquired by the first imager thereof.

FIG. 7 is a plan view schematically showing a portion of a field where a plurality of curved crop rows are provided on the ground surface.

FIG. 8 is a block diagram showing an example configuration of a travel control system according to an example embodiment of the present disclosure.

FIG. 9 is a block diagram showing an example hardware configuration of a processor.

FIG. 10 is a flowchart showing an example algorithm by which the travel control system according to an example embodiment of the present disclosure determines a travel path of the agricultural machine based on results of detection of a crop row or a ridge.

FIG. 11 is an image corresponding to one frame of image in first time-series images acquired by the first imager mounted on the agricultural machine.

FIG. 12A schematically shows an example of image frontward of the agricultural machine that is included in the first time-series images acquired by the first imager during travel of the agricultural machine.

FIG. 12B schematically shows an example of image rearward of the agricultural machine that is included in the second time-series images acquired by a second imager during travel of the agricultural machine.

FIG. 13 is a perspective view schematically showing positions of each of a camera coordinate system of the imager at a first pose and a camera coordinate system of an imager at a second pose, with respect to a reference plane Re.

FIG. 14 is a plan view schematically showing positions of each of a first region of interest and a second region of interest respectively included in a first plan-view image and a second plan-view image in a vehicle coordinate system, with respect to the agricultural machine.

FIG. 15 is a flowchart showing an example algorithm according to implementation example 1.

FIG. 16 is a plan view schematically showing an example of first fitted line, an example of second fitted line and an example of approximation curve on the vehicle coordinate system.

FIG. 17 is a plan view schematically showing a first portion and a second portion respectively located in the first region of interest and a second region of interest in the vehicle coordinate system while the agricultural machine is traveling along a straight crop row.

FIG. 18 is a plan view schematically showing an example of control points and an example of approximation curve on the vehicle coordinate system.

FIG. 19 is a plan view provided to describe travel control along the travel path set on the vehicle coordinate system.

FIG. 20 is a flowchart showing an example algorithm according to implementation example 2.

FIG. 21 is a plan view schematically showing an example of positions of each of the first fitted line, the second fitted line, a front reference point and a rear reference point on the vehicle coordinate system, with respect to the agricultural machine.

FIG. 22 is a plan view schematically showing the first region of interest, the second region of interest, the first fitted line and the second fitted line in the vehicle coordinate system while the agricultural machine is traveling along a straight crop row.

FIG. 23 is a perspective view showing an example of external appearance of the agricultural machine according to an example embodiment of the present disclosure.

FIG. 24 is a side view schematically showing an example of the agricultural machine to which an implement is attached.

FIG. 25 is a block diagram showing an example schematic configuration of the agricultural machine and the implement.

### DETAILED DESCRIPTION OF THE EXAMPLE EMBODIMENTS

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description and to facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following example embodiments are only exemplary, and the techniques and example embodiments according to an example embodiment of the present disclosure are not limited to the following example embodiments. For example, numerical values, shapes, materials, steps, orders of steps, layout in a display screen, etc., that are indicated in the following example embodiments are only exemplary, and admit of various modifications so long as it makes technological sense. Any one implementation may be combined with another so long as it makes technological sense to do so.

As used in the present disclosure, an “agricultural machine” broadly includes any machine that performs basic tasks of agriculture, e.g., “tilling”, “planting”, and “harvesting”, in fields. An agricultural machine is a machine that has a functionality and structure to perform agricultural operations such as tilling, seeding, preventive pest control, manure spreading, planting of crops, or harvesting for the ground surface within a field. Such agricultural work, tasks, or operations may be referred to as “groundwork”, or simply as “work”, “tasks”, or “operations”. An agricultural machine does not need to include a traveling device moving the agricultural machine itself, and may travel by being attached to, or towed by, another vehicle including a traveling device. Not only does a work vehicle, such as a tractor, function as an “agricultural machine” by itself alone, but an implement that is attached to, or towed by, a work vehicle and the work vehicle may, as a whole, function as one “agricultural machine”. Examples of agricultural machines include tractors, vehicles for crop management, vegetable transplanters, mowers, and field-moving robots.

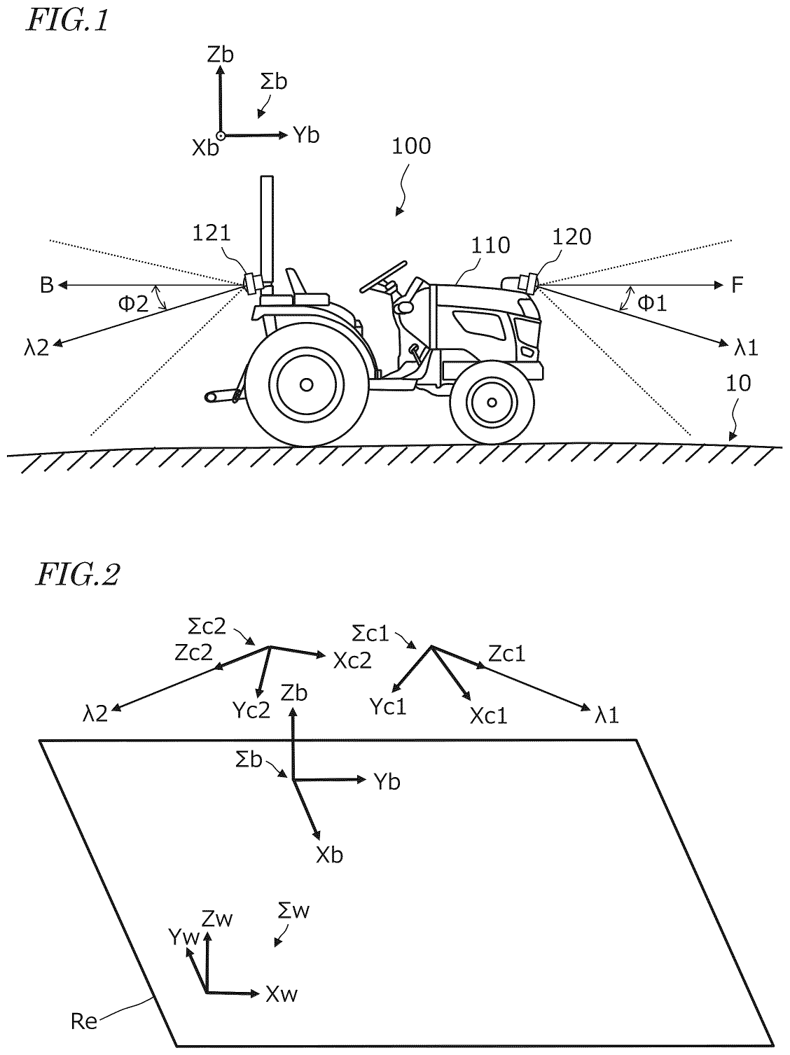

First, with reference to FIG. 1 through FIG. 7, an overview of a travel control system according to an example embodiment of the present disclosure will be described.

A travel control system according to an example embodiment of the present disclosure includes first and second imagers used as being attached to an agricultural machine. The first and second imagers are each secured to the agricultural machine so as to capture an image of the ground surface on which the agricultural machine travels and thus acquire time-series images including at least a portion of the ground surface. Specifically, the first imager is attached to the agricultural machine so as to face in a first direction. The first imager acquires first time-series images including a first portion of crop rows or ridges in a field. The second imager is attached to the agricultural machine so as to face in a second direction different from the first direction. The second imager acquires second time-series images including a second portion of the crop rows or the ridges in the field. The first portion and the second portion of the crop rows or the ridges will be described below.

The first direction and the second direction are respectively directions in which camera optical axes of the first and second imagers are directed. In an example embodiment of the present disclosure, the first direction is a forward direction for the agricultural machine, and the second direction is a rearward direction for the agricultural machine. In more detail, as described below, the first direction is a direction inclined with respect to a forward traveling direction for the agricultural machine toward the ground surface. The second direction is a direction inclined with respect to a backward traveling direction for the agricultural machine, opposite to the forward traveling direction, toward the ground surface. Note that neither the first direction nor the second direction is limited to such a direction. The first imager acquires images, of an area frontward of the agricultural machine, that form the first time-series images. The second imager acquires images, of an area rearward of the agricultural machine, that form the second time-series images. The first time-series images and the second time-series images are each typically time-series color images, but may be monochrome images.

FIG. 1 schematically shows how a first imager 120 and a second imager 121 attached to an agricultural machine 100, such as, for example, a tractor, a vehicle for crop management or the like captures images of a ground surface 10. In the example of FIG. 1, the agricultural machine 100 includes a vehicle body 110 capable of traveling. In the example of FIG. 1, the first imager 120 is secured frontward of the vehicle body 110, and the second imager 121 is secured rearward of the vehicle body 110. Note that neither the first imager 120 nor the second imager 121 is limited to being attached to such a position. For example, the first imager 120 may be secured sideward of the vehicle body 110 with a camera optical axis thereof being directed in the forward traveling direction. The second imager 121 may be secured sideward of the vehicle body 110 with a camera optical axis thereof being directed in the backward traveling direction, opposite to the forward traveling direction, or in a direction crossing the forward traveling direction.

For referencing sake, FIG. 1 shows a vehicle coordinate system Σb having an Xb axis, a Yb axis, and a Zb axis that are orthogonal to one another. The vehicle coordinate system Σb is a coordinate system that is fixed to the agricultural machine 100. The origin of the vehicle coordinate system Σb may be set on, for example, a rear wheel axis of the agricultural machine 100 as seen in a plan view seen from above the ground surface 10 along which the agricultural machine 100 travels, as described below. In the figure, for ease of viewing, the origin of the vehicle coordinate system Σb is illustrated as lying external to the agricultural machine 100. In the vehicle coordinate system Σb according to an example embodiment of the present disclosure, the Yb axis coincides with the forward traveling direction (direction of arrow F) while the agricultural machine 100 is traveling straight. As viewed from the coordinate origin in a positive direction along the Yb axis, the Xb axis coincides with the directly right direction, and the Zb axis coincides with the vertically upward direction.

The first and second imagers 120 and 121 are each, for example, an onboard camera that includes a CCD (Charge Coupled Device) or a CMOS (Complementary Metal Oxide Semiconductor) image sensor. The first and second imagers 120 and 121 according to an example embodiment of the present disclosure are each a monocular camera that is capable of capturing motion pictures at a frame rate of, for example, 3 frames/second (fps: frames per second) or above.

FIG. 2 is a perspective view schematically showing the relationship among the aforementioned vehicle coordinate system Σb, a camera coordinate system Σc1 of the first imager 120, a camera coordinate system Σc2 of the second imager 121, and a world coordinate system Σw that is fixed to the ground surface 10. The camera coordinate system Σc1 has an Xc1 axis, a Yc1 axis, and a Zc1 axis that are orthogonal to one another. The camera coordinate system Σc2 has an Xc2 axis, a Yc2 axis, and a Zc2 axis that are orthogonal to one another. The world coordinate system Σw has an Xw axis, a Yw axis, and a Zw axis that are orthogonal to one another. In the example of FIG. 2, the Xw axis and the Yw axis of the world coordinate system Σw are on a reference plane Re that expands along the ground surface 10.

The first imager 120 is mounted frontward of the agricultural machine 100 so as to face in the first direction (so as to face forward). Therefore, the position and orientation of the camera coordinate system Σc1 with respect to the vehicle coordinate system Σb are fixed in a known state. The Zc1 axis of the camera coordinate system Σc1 is on a camera optical axis λ1. In the illustrated example, the camera optical axis λ1 is inclined with respect to the forward traveling direction F of the agricultural machine 100 toward the ground surface 10, with an angle of depression Φ that is greater than 0°.

The second imager 121 is mounted rearward of the vehicle body 110 so as to face in the second direction (so as to face rearward). Therefore, the position and orientation of the camera coordinate system Σc2 with respect to the vehicle coordinate system Σb are fixed in a known state like in the case of the camera coordinate system Σc1. The Zc2 axis of the camera coordinate system Σc2 is on a camera optical axis λ2. In the illustrated example, the camera optical axis λ2 is inclined with respect to the backward traveling direction B, opposite to the forward traveling direction F, of the agricultural machine 100 toward the ground surface 10, with an angle of depression Φ that is greater than 0°.

The forward traveling direction F and the backward traveling direction B for the agricultural machine 100 are generally parallel to the ground surface 10, along which the agricultural machine 100 travels. The angles of depression Φ1 and Φ2 may each be set to a range of, e.g., not less than 0° and not more than 60θ. The angles of depression Φ1 and Φ2 may be the same as, or different from, each other. In the case where the positions at which the two imagers are mounted are close to the ground surface 10, the orientations of the camera optical axes λ1 and λ2 may each be set so that the angles of depression Φ1 and Φ2 each have a negative value, that is, so that the orientations of the camera optical axes λ1 and λ2 each have a positive angle of elevation.

While the agricultural machine 100 is traveling on the ground surface 10, the camera coordinate systems Σc1 and Σb2 and the vehicle coordinate system Σb translate relative to the world coordinate system Σw. When the agricultural machine 100 rotates or swings in directions of pitch, roll, and yaw during travel, the vehicle coordinate system Σb and the camera coordinate systems Σc1 and Σc2 rotate relative to the world coordinate system Σw. In the following description, for simplicity, it is assumed that the agricultural machine 100 does not rotate in the pitch or roll direction and that the agricultural machine 100 moves essentially parallel to the ground surface 10.

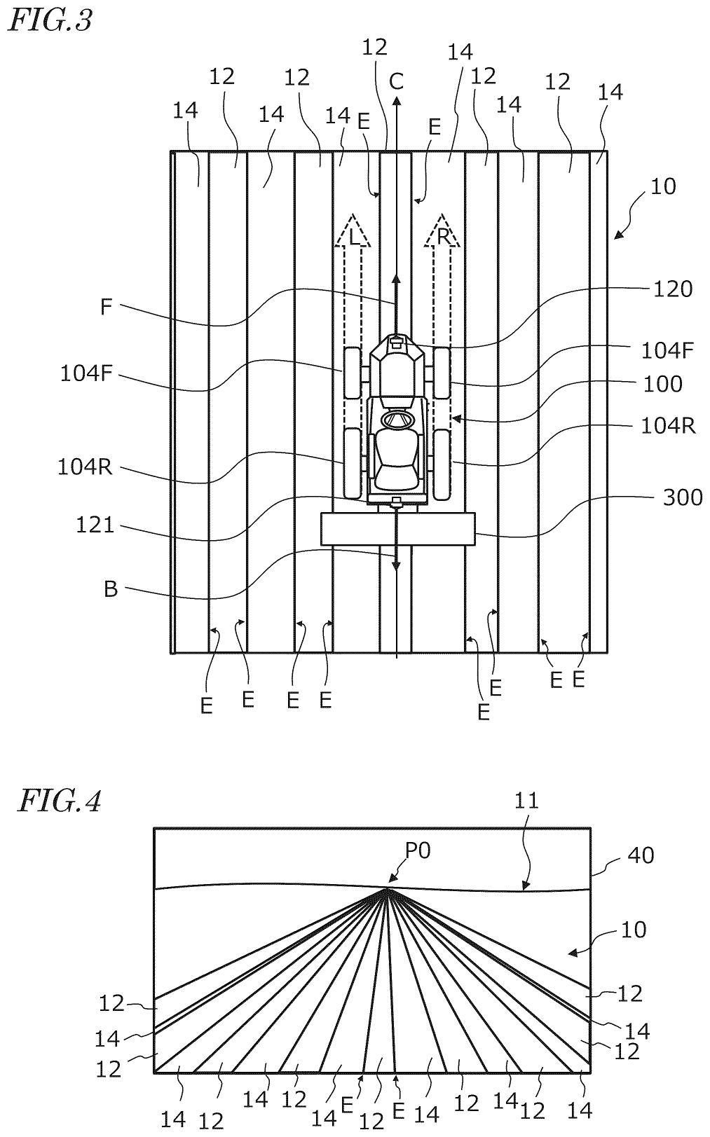

FIG. 3 is a plan view schematically showing a portion of a field in which a plurality of crop rows 12 are provided on the ground surface 10. A crop row 12 is a row that is formed by crops or seedlings being continuously planted on the ground surface 10 of the field in one direction. For example, the crop row 12 may be an aggregation of crops that are planted in a ridge of the field. A row formed by seedlings being continuously planted on the ground surface 10 of the field in one direction may be referred to as a “seedling row”. As described above, each individual crop row 12 is a row that is formed by an aggregation of crops that have been planted in the field. Therefore, strictly describing, the shape of a crop row may be complex depending on the shapes of crops and the positional arrangement of crops. The width of a crop row 12 changes as the crops growth. Between each two crop rows 12 adjacent to each other, a belt-shaped intermediate region 14, in which no crops have been planted, exists. Such intermediate regions 14 are each a region that is interposed between two edge lines E facing each other between two adjacent crop rows 12. In the case where a plurality of crops are planted for one ridge in a width direction of the ridge, a plurality of crop rows 12 are formed on the one ridge. In such a case, among the plurality of crop rows 12 that are formed on the ridge, an edge line E of the crop row 12 that is located at an end of the width direction of the ridge serves as a delineator of an intermediate region 14. In other words, an intermediate region 14 lies between the edge lines E of crop rows 12 that are located at ends of the ridge in the width direction, among the edge lines E of the plurality of crop rows 12.

Since such an intermediate region 14 functions as a region (work path) along which the wheels of the agricultural machine 100 may pass, the “intermediate region” may be referred to as a “work path”.

In the present disclosure, an “edge line” of a crop row means a reference line segment (which may also include a curve) defining a travel path for an agricultural machine. The “travel path” may be referred to as a “target path”. Such reference line segments may be defined as both of two ends of a belt-shaped region (work path) along which the wheels of the agricultural machine are allowed to pass. A specific method for determining the “edge lines” of a crop row will be described below.

FIG. 3 schematically shows one agricultural machine 100 traveling in a field in which the crop rows 12 are formed. The agricultural machine 100 includes left and right front wheels 104F and left and right rear wheels 104R as traveling devices, and tows an implement 300. The front wheels 104F are wheels responsible for steering.

In the example shown in FIG. 3, thick broken-lined arrows L and R are respectively indicated for the work paths 14 that are located on opposite sides of one crop row 12 in the middle. While the agricultural machine 100 is traveling on a travel path that is indicated by solid-lined arrow C, the front wheels 104F and the rear wheels 104R of the agricultural machine 100 are required to move along arrows L and R in the work paths 14, so as not to step on the crop row 12. In an example embodiment of the present disclosure, as described below, the first and second imagers 120 and 121 attached to the agricultural machine 100 are used to detect the first portion and the second portion included in the crop row 12, and the travel path is determined based on a fitted line of the first portion and a fitted of the second portion in the vehicle coordinate system Σb. Therefore, it is made possible to control the steering and the travel of the agricultural machine 100 so that the front wheels 104F and the rear wheels 104R move along arrows L and R in the work paths 14. Controlling the steering and the travel of the agricultural machine 100 based on the results of detection of the crop row in this manner may be referred to as “row-following travel control”.

FIG. 4 schematically shows an example of frontward image 40 acquired by the first imager 120 of the agricultural machine 100 shown in FIG. 3. As understood from FIG. 1 or FIG. 2, the description on the frontward image 40 is also applicable to a rearward image acquired by the second imager 121. In the example of the image 40 shown in FIG. 4, the agricultural machine 100 travels on the travel path indicated by solid-lined arrow C as shown in FIG. 3. Therefore, the plurality of crop rows 12 and the intermediate regions (work paths) 14 extending in parallel to each other on the ground surface 10 cross each other at a vanishing point P0 on a horizon 11. The vanishing point P0 is located in a central region of the image 40.

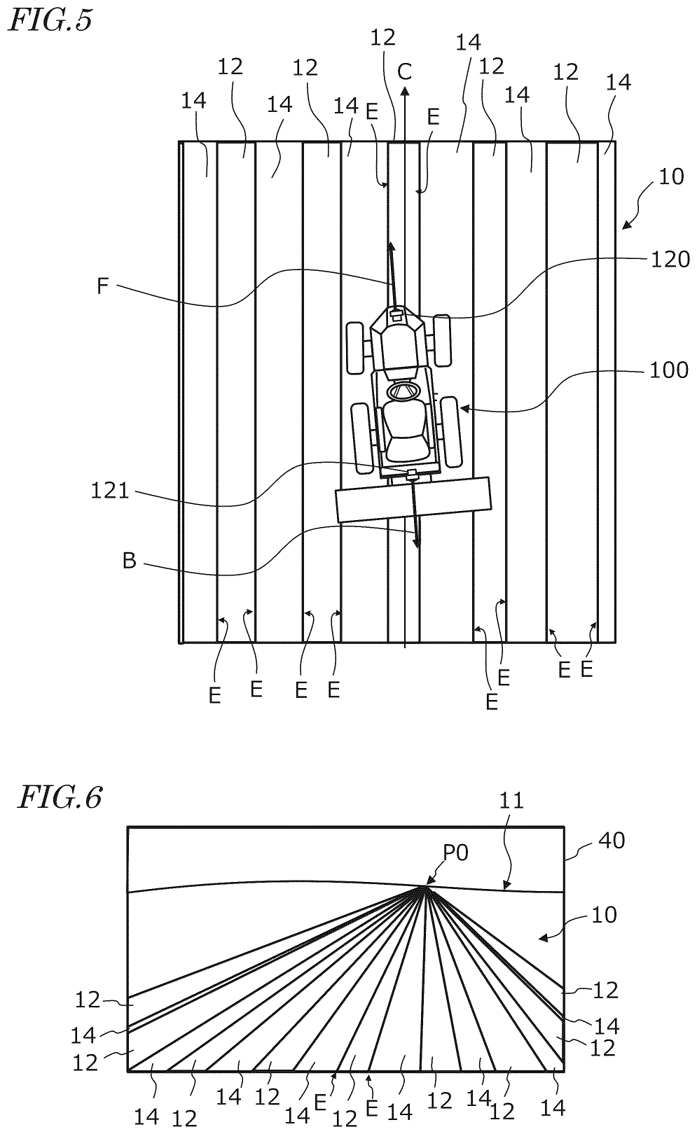

FIG. 5 is a plan view schematically showing a state where the forward traveling direction F for the agricultural machine 100 is inclined with respect to the direction in which the crop rows 12 extend. FIG. 6 schematically shows an example of the frontward image 40 acquired by the first imager 120 of the agricultural machine 100 shown in FIG. 5. In the case where the forward traveling direction F for the agricultural machine 100 is inclined with respect to the direction in which the crop rows 12 extend (direction parallel to arrow C), the vanishing point P0 is located in a right or left region of the image 40. In the example shown in FIG. 6, the vanishing point P0 is located in the right region of the image 40.

The travel control system according to an example embodiment of the present disclosure further includes a processor and a controller. The processor is configured or programmed to detect the crop rows or the ridges included in the frontward image and the rearward image respectively acquired by the first imager 120 and the second imager 121 attached to the agricultural machine 100, and linearly approximates the detected crop rows or ridges on the vehicle coordinate system to find a fitted line. The processor further determines the travel path based on the two fitted lines found from the frontward and rearward images. The controller is configured or programmed to control the travel of the agricultural machine 100 based on the travel path.

FIG. 3 schematically shows a state where the agricultural machine 100 is steered to reduce the positional deviation and the heading deviation with respect to the travel path (arrow C) and as a result, the position and orientation (angle in the yaw direction) of the agricultural machine 100 in the state shown in FIG. 5 are adjusted. The left and right wheels of the agricultural machine 100 in the state of FIG. 3 are respectively located on the lines indicated by arrows L and R in the work paths 14. While the agricultural machine 100 is traveling along the travel path indicated by central arrow C, an automatic steering device in the agricultural machine 100 controls the steering angles of the wheels responsible for steering so that neither the front wheels 104F nor the rear wheels 104R deviate from the work paths 14.

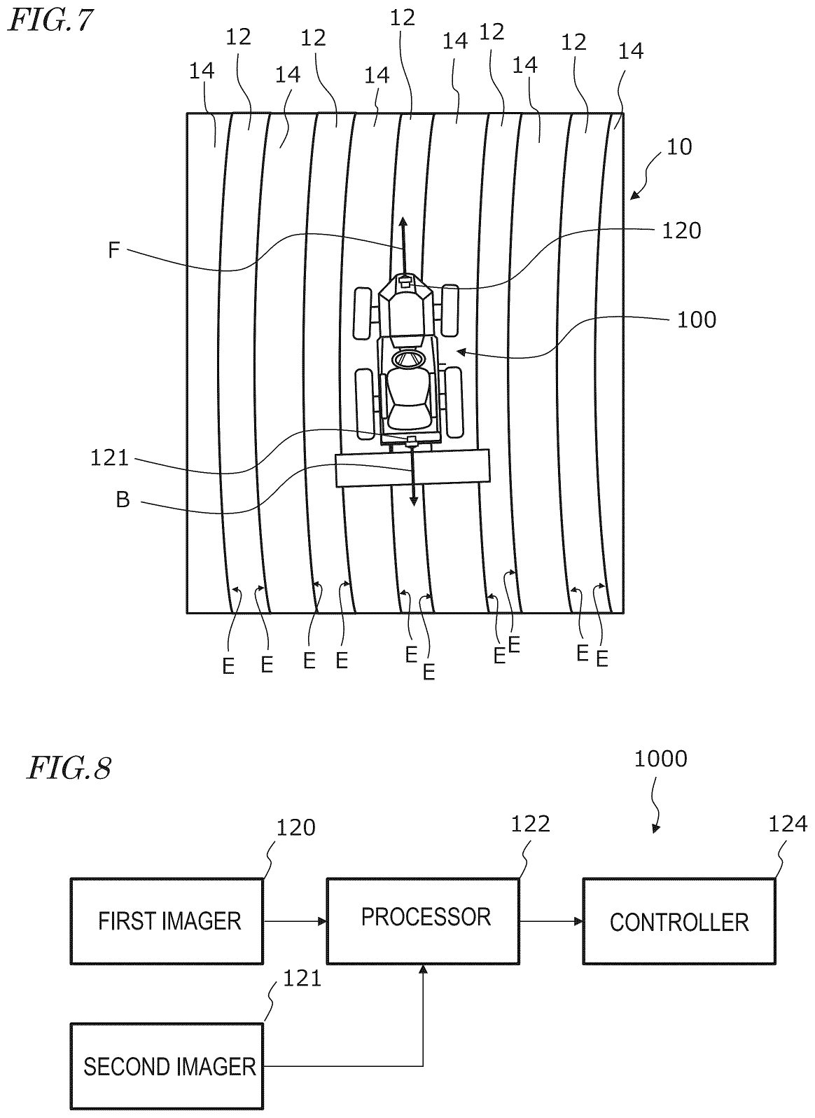

FIG. 7 is a plan view schematically showing a portion of a field in which a plurality of curved crop rows 12 are provided on the ground surface 10. According to an example embodiment of the present disclosure, even in a field in which such curved crop rows or ridges are formed, it is made possible to correctly detect the positions of the crop rows or ridges from the frontward and rearward images acquired by the two imagers and to precisely control the steering and the travel of the agricultural machine 100 along the crops rows or the ridges, owing to a travel path determination method described below. In other words, the travel path on which the agricultural machine 100 is to proceed can be appropriately generated. As a result, it is made possible, by automatic steering, to control the travel of the agricultural machine 100 so that the front wheels 104F and the rear wheels 104R of the agricultural machine 100 move along arrows L and R in the work paths 14 (that is, it is made possible to perform the row-following travel control).

Hereinafter, a configuration and an operation of the travel control system according to an example embodiment of the present disclosure will be described in detail.

FIG. 8 is a block diagram showing an example configuration of a travel control system 1000 according to an example embodiment of the present disclosure. The travel control system 1000 includes the first and second imagers 120 and 121, a processor 122, and a controller 124. The processor 122 is configured or programmed to execute image processing on the first time-series images acquired by the first imager 120 and the second time-series images acquired by the second imager 121 to determine a travel path of the agricultural machine 100. The controller 124 is configured or programmed to control the travel of the agricultural machine 100 based on the travel path or to control the travel of the agricultural machine 100 based on the output from the processor 122. The controller 124 may be implemented by an electronic control unit (ECU) for automatic steering control described below, and is included in, for example, a self-driving device that controls the travel of the agricultural machine 100. The ECU is a computer for onboard use.

The processor 122 may be implemented by an ECU for image recognition. The processor 122 is connected to the first and second imagers 120 and 121 via serial signal lines, e.g., wire harnesses or the like, so as to receive image data that is output from the first and second imagers 120 and 121. A portion of the image recognition processing that is executed by the processor 122 may be executed inside each of the first and second imagers 120 and 121 (inside each of camera modules).

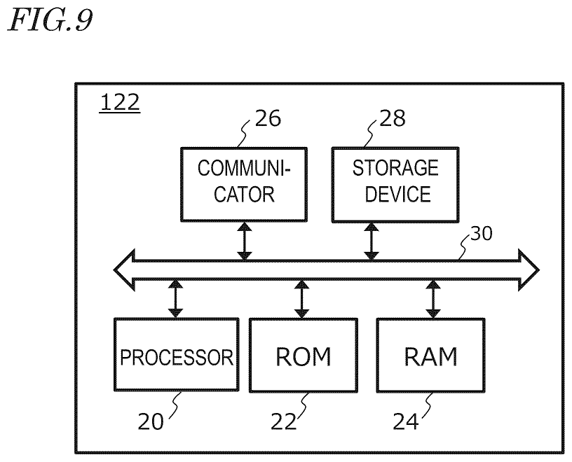

FIG. 9 is a block diagram showing an example hardware configuration of the processor 122. The processor 122 includes a processor 20, a ROM (Read Only Memory) 22, a RAM (Random Access Memory) 24, a communicator 26, and a storage device 28. These component elements are connected to one another via buses 30.

The processor 20 may be a semiconductor integrated circuit, and may be referred to also as a central processing unit (CPU) or a microprocessor. The processor 20 may include an image processing unit (GPU). The processor 20 consecutively executes a computer program describing a group of predetermined instructions stored on the ROM 22 to realize processing that is needed for the detection of the crop rows or the ridges or for the generation of the travel path according to an example embodiment of the present disclosure. A portion of, or the entirety of, the processor 20 may be an FPGA (Field Programmable Gate Array), an ASIC (Application Specific Integrated Circuit), or an ASSP (Application Specific Standard Product) each having a CPU mounted thereon.

The communicator 26 is an interface to perform data communication between the processor 122 and an external computer. The communicator 26 can perform wired communication based on a CAN (Controller Area Network) or the like, or wireless communication complying with the Bluetooth (registered trademark) protocols and/or the Wi-Fi (registered trademark) standards.

The storage device 28 can store data on images acquired from the first and second imagers 120 and 121 or images which are under processing. Examples of the storage device 28 include a hard disc drive and a non-volatile semiconductor memory.

The hardware configuration of the processor 122 is not limited to the above-described example. It is not required that a part of, or the entirety of, the processor 122 is mounted on the agricultural machine 100. By utilizing the communicator 26, one or more computers located outside the agricultural machine 100 may be allowed to function as a portion of, or an entirety of, the processor 122. For example, a server computer that is connected to a network may function as a portion of, or an entirety of, the processor 122. By contrast, a computer mounted on the agricultural machine 100 may perform all the functions that are required of the processor 122.

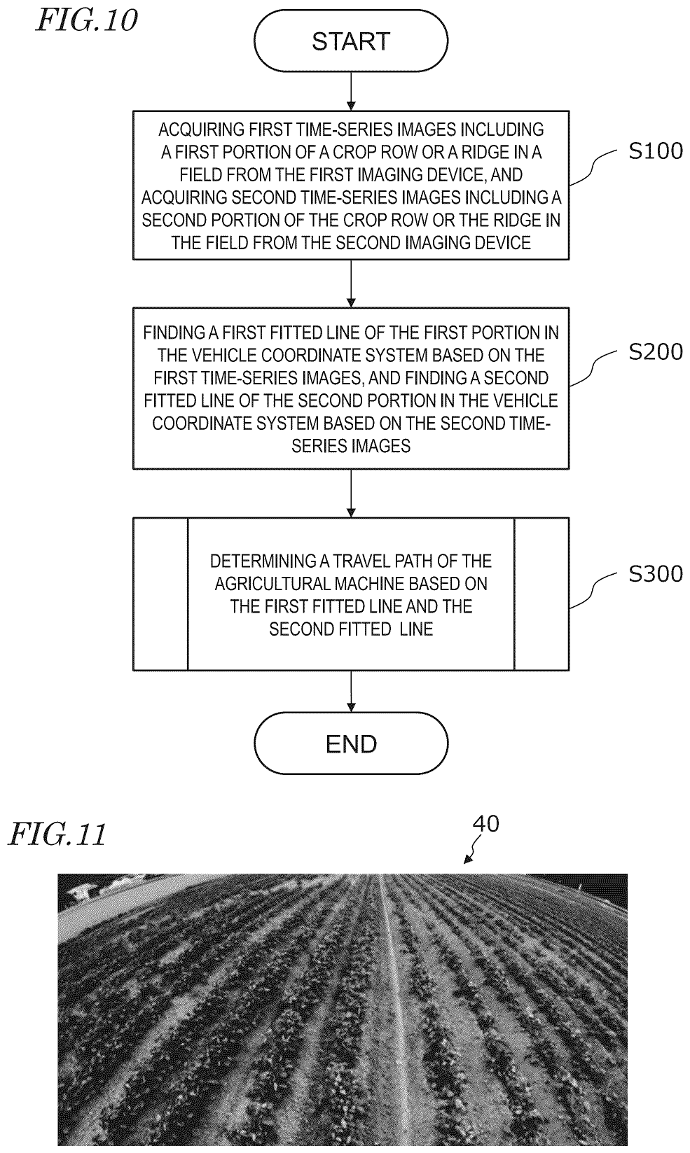

FIG. 10 is a flowchart showing an example algorithm by which the travel control system according to an example embodiment of the present disclosure determines the travel path of the agricultural machine based on the results of detection of the crop rows or the ridges. In an example embodiment of the present disclosure, the processor 122 is configured or programmed to execute operations S100, S200 and S300 described below.

(S100) Acquires, from the first imager 120, the first time-series images including the first portion of the crop rows or the ridges in the field, and acquires, from the second imager 121, the second time-series images including the second portion of the crop rows or the ridges in the field.

(S200) Finds a first fitted line of the first portion in the vehicle coordinate system Σb based on the first time-series images, and finds a second fitted line of the second portion in the vehicle coordinate system Σb based on the second time-series images.

(S300) Determines the travel path of the agricultural machine based on the first fitted line and the second fitted line.

Hereinafter, a specific example of the operations S100, S200 and S300 will be described in detail.

The first time-series images form an aggregation of images that are chronologically acquired by the first imager 120 through image capturing. Each image is formed of a frame-by-frame group of pixels. This is also true with the second time-series images. For example, in the case where the first imager 120 outputs images at a frame rate of 30 frames/second, the processor 122 can acquire new images with a period of about 33 milliseconds. This is applicable to the second image device 121. As compared with a common automobile that travels on public roads, the agricultural machine 100, such as a tractor or the like, travels in a field at a speed which is relatively low, e.g., about 10 kilometers per hour or lower. In the case where the speed is 10 kilometers per hour, a distance of about 6 centimeters is travelled in about 33 milliseconds, for example. Therefore, the processor 122 may acquire images with a period of, for example, about 100 to 300 milliseconds, and does not need to process all the frame of images captured by the first imager 120 and the second imager 121. The period with which the images to be processed by the processor 122 are acquired may be automatically changed by the processor 122 in accordance with the travel speed of the agricultural machine 100.

FIG. 11 shows an example of one-frame image 40, among the first time-series images acquired by the first imager 120 mounted on the agricultural machine 100 (which is, in this example, a monocular camera). The image of FIG. 11 shows crop rows planted in the form of rows on the ground surface of a field. In this example, the crop rows are arranged essentially in parallel and at equal intervals on the ground surface, such that the camera optical axis λ1 of the first imager 120 is inclined with respect to the forward traveling direction F for the agricultural machine 100 toward the ground surface (see FIG. 1 and FIG. 3). In other words, the camera optical axis λ1 does not need to be parallel to the forward traveling direction F for the agricultural machine 100 as described above, but may be incident on the ground surface frontward of the agricultural machine 100 in the forward traveling direction F therefor.

The second imager 121 also acquires an image similar to the image 40, and the image acquired by the second imager 121 shows crop rows planted in the form of rows on the ground surface of the field and arranged essentially in parallel and at equal intervals. The camera optical axis λ2 of the second imager 121 is inclined with respect to the backward traveling direction B for the agricultural machine 100 toward the ground surface (see FIG. 1 and FIG. 3). In other words, like the camera optical axis λ1, the camera optical axis 12 does not need to be parallel to the backward traveling direction B, but may be incident on the ground surface frontward of the agricultural machine 100 in the backward traveling direction B therefor.

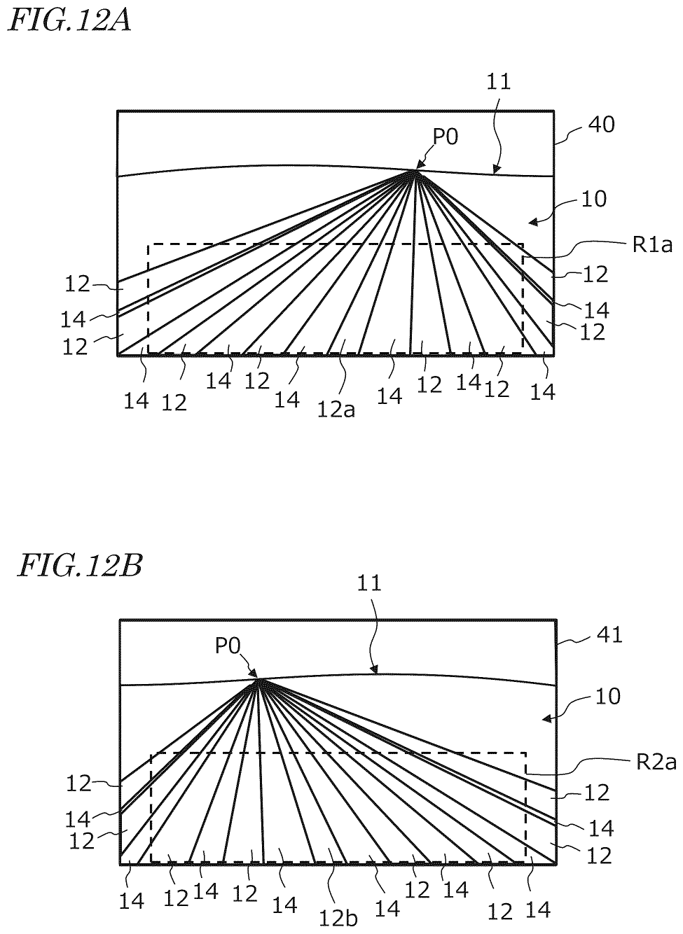

A case where the agricultural machine 100 travels in the field along the curved crop rows shown in FIG. 7 will be discussed. FIG. 12A shows an example of frontward image 40 included in the first time-series images acquired by the first imager 120 during the travel of the agricultural machine 100. FIG. 12B shows an example of rearward image 41 included in the second time-series images acquired by the second imager 121 during the travel of the agricultural machine 100. FIG. 12 and FIG. 12B each show the crop rows 12 with straight lines for the sake of simplicity, but the crop rows 12 in each of actually captured images include curved portions.

In the operation S100, the processor 122 acquires the first time-series images including the first portion of the crop rows 12 in the field from the first imager 120, and acquires the second time-series images including the second portion of the crop rows or the ridges in the field from the second imager 121. The first portion and the second portion of the crop rows 12 in the field are each a portion of the crop rows as a target of crop row detection required for the row-following travel control. A first portion 12a of the crop rows 12 in the field is a portion located at the center of the plurality of crop rows 12 included in the frontward image 40 shown in FIG. 12A. A second portion 12b is a portion located at the center of the plurality of crop rows 12 included in the rearward image 41 shown in FIG. 12B.

In the operation S200, the processor 122 finds the first fitted line of the first portion 12a in the vehicle coordinate system Σb based on the first time-series images, and finds the second fitted line of the second portion 12b in the vehicle coordinate system Σb based on the second time-series images. For example, the processor 122 can transform the first time-series images and the second time-series images respectively into plan-view images and find a fitted line from each of the plan-view images. Now, an example method for transforming the first time-series images into first plan-view images will be described regarding the first imager 120. This method can also be used to transform the second time-series images acquired by the second imager 121 into second plan-view images. Such transformation is implemented by, for example, homography transformation (planar perspective projection). Homography transformation is a type of geometrical transformation, and allows a point on a given plane in a three-dimensional space to be transformed into a point on another optional plane. Each of plan-view images is an image as seen from above the ground surface on which the agricultural machine 100 travels, and may be referred to as an “overhead-view image”. A plan-view image in an example embodiment of the present disclosure is associated with the vehicle coordinate system Σb.

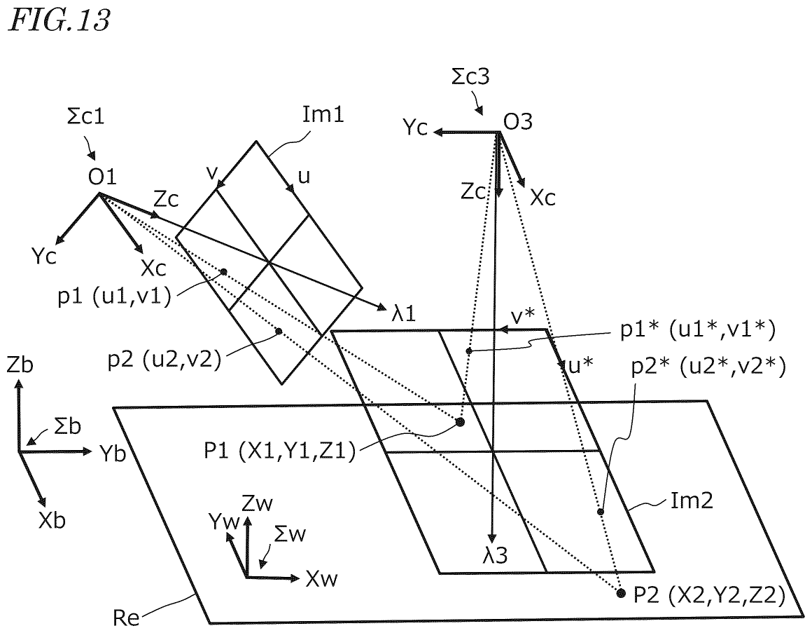

FIG. 13 is a perspective view schematically showing positions of each of the camera coordinate system Σc1 of an imager at a first pose (position and orientation) and a camera coordinate system Σc3 of an imager at a second pose, with respect to the reference plane Re. FIG. 13 also shows the vehicle coordinate system Σb. In the illustrated example, the camera coordinate system Σc1 is inclined so that a Zc axis thereof obliquely crosses the reference plane Re. The imager at the first pose corresponds to the first imager 120 mounted on the agricultural machine 100. By contrast, the camera coordinate system Σc3 has a Zc axis thereof orthogonal to the reference plane Re. In the case where the agricultural machine 100 does not rotate in the pitch direction or the roll direction, a plane including the Xb axis and the Yb axis of the vehicle coordinate system Σb (hereinafter, referred to as a “vehicle coordinate system plane”) is parallel to the reference plane Re. Therefore, the Zc axis of the camera coordinate system Σc3 is also orthogonal to the vehicle coordinate system plane. In other words, the camera coordinate system Σc3 is located so as to acquire an overhead-view image as seen from right above the reference plane Re or the vehicle coordinate system plane along the normal direction thereto.

At a position that is distant from the origin O1 of the camera coordinate system Σc1 by the focal length of the camera in the direction of the Zc axis, a phantom image plane Im1 exists. The image plane Im1 is orthogonal to the Zc axis and the camera optical axis 11. A pixel position on the image plane Im1 is defined by an image coordinate system having a u axis and a v axis that are orthogonal to each other. For example, it is assumed that a point P1 and a point P2 located on the reference plane Re have coordinates (X1, Y1, Z1) and (X2, Y2, Z2) respectively in the world coordinate system Σw. In the example of FIG. 13, the Xw axis and the Yw axis of the world coordinate system Σw are on the reference plane Re. Therefore, Z1=Z2=0. The reference plane Re is set so as to expand along the ground surface.

Through perspective projection based on a pinhole camera model, the point P1 and the point P2 on the reference plane Re are transformed, respectively, into a point p1 and a point p2 on the image plane Im1 of the imager at the first pose. On the image plane Im1, the point p1 and the point p2 are at pixel positions indicated by coordinates (u1,v1) and (u2,v2), respectively.

In the case where the imager is at the second pose, a phantom image plane Im2 exists at a position that is distant from the origin O3 of the camera coordinate system Σc3 by the focal length of the camera in the direction of the Zc axis. In this example, the image plane Im2 is parallel to the reference plane Re, and is located on the vehicle coordinate system plane. A pixel position on the image plane Im2 is defined by the vehicle coordinate system Σb. The vehicle coordinate system Σb has a unit of, for example, a meter. Through perspective projection, the point P1 and the point P2 on the reference plane Re are transformed, respectively, into a point p1* and a point p2* on the image plane Im2. On the image plane Im2, the point p1* and point p2* are at pixel positions indicated by coordinates (u1*,v1*) and (u2*,v2*) on the vehicle coordinate system Σb, respectively.

Once the relative positions of the camera coordinate systems Σc1 and Σc2 with respect to the reference plane Re (world coordinate system Σw) are given, from a given point (u,v) on the image plane Im1, a point (u*,v*) corresponding thereto on the image plane Im2 can be found through homography transformation. In the case where the point coordinates are expressed by a homogeneous coordinate system, such homography transformation is defined by a transformation matrix H of 3 rows×3 columns.

$$( \begin{matrix}u * \\ v * \\ 1\end{matrix} ) = H ( \begin{matrix}u \\ v \\ 1\end{matrix} ) \qquad [ eq . 1 ]$$

The contents of the transformation matrix H are defined by numerical values of h₁₁, h₁₂, . . . , h₃₂, as indicated below.

$$( \begin{matrix}u * \\ v * \\ 1\end{matrix} ) = ( \begin{matrix}h 11 & h 12 & h 13 \\ h 21 & h 22 & h 23 \\ h 31 & h 32 & 1\end{matrix} ) ( \begin{matrix}u \\ v \\ 1\end{matrix} ) \qquad [ eq . 2 ]$$

The eight numerical values (h₁₁, h₁₂, . . . , h₃₂) can be calculated by a known algorithm once an image of a calibration board that is placed on the reference plane Re is captured by the imager attached to the agricultural machine 100.

In the case where a point on the reference plane Re has coordinates (X, Y, 0), the coordinates of the corresponding points on the camera image planes Im1 and Im2 are associated with the point (X, Y, 0) by respective homography transformation matrices H1 and H2, as indicated by equation 3 and equation 4 below.

$$( \begin{matrix}u \\ v \\ 1\end{matrix} ) = H 1 ( \begin{matrix}X \\ Y \\ 1\end{matrix} ) \qquad [ eq . 3 ]$$

$$( \begin{matrix}u * \\ v * \\ 1\end{matrix} ) = H 2 ( \begin{matrix}X \\ Y \\ 1\end{matrix} ) \qquad [ eq . 4 ]$$

From the above two equations, the following equation is derived. As is clear from this equation, the transformation matrix H is equal to H2H1⁻¹. H1⁻¹ is an inverse of H1.

$$( \begin{matrix}u * \\ v * \\ 1\end{matrix} ) = H 2 H {1}^{- 1} ( \begin{matrix}u \\ v \\ 1\end{matrix} ) \qquad [ eq . 5 ]$$

The contents of the transformation matrices H1 and H2 depend on the reference plane Re. Therefore, when the position of the reference plane Re changes, the contents of the transformation matrix H also change.

By utilizing such homography transformation, a plan-view image of the ground surface can be generated from an image of the ground surface acquired by the imager at the first pose (imager attached to the agricultural machine). In other words, through the homography transformation, coordinates of a given point on the image plane Im1 of the imager can be transformed into coordinates of a point that is on the image plane Im2 of a phantom imager at a predetermined pose with respect to the reference plane Re.

After calculating the contents of the transformation matrix H, the processor 122 executes a software program based on the aforementioned algorithm to generate, from time-series images output from the imager, an overhead-view image of the ground surface 10 as seen from above. Before the processing of generating the overhead-view image, pre-processing such as white balancing, noise reduction or the like may be applied to the time-series images.

In the above description, it is assumed that points in the three-dimensional space (e.g., P1, P2) are all located on the reference plane Re (e.g., Z1=Z2=0). In the case where the height of a crop with respect to the reference plane Re is non-zero, in the post-homography transformation plan-view image, the position of a corresponding point is shifted from a proper position thereof. In order to reduce or prevent an increase in the amount of shift, it is desirable that the height of the reference plane Re is close to the height of the crop as a target of detection. On the ground surface 10, bumps and dents, e.g., ridges, furrows, trenches or the like, may exist. In such a case, the reference plane Re may be offset upward from the bottoms of such bumps and dents. The offset distance may be appropriately set depending on the bumps and dents of the ground surface 10 on which crops are planted.

When the vehicle body 110 (see FIG. 1) makes a motion of roll or pitch while the agricultural machine 100 is traveling on the ground surface 10, the pose of the imager 120 is changed. Therefore, the contents of the transformation matrix H may change. In such a case, the rotation angle of the roll and the pitch of the vehicle body 110 can be measured by an inertial measurement unit (IMU), so that the transformation matrix H1 and the transformation matrix H2 are corrected in accordance with the change in the pose of the imager.

The processor 122 can transform the second time-series images acquired by the second imager 121 into the second plan-view images by a method substantially the same as the method used to transform the first time-series images acquired by the first imager 120 into the first plan-view images.

In this manner, the processor 122 transforms the first time-series images and the second time-series images respectively into the first plan-view images and the second plan-view images on the vehicle coordinate system Σb. In other words, the processor 122 generates the first plan-view images and the second plan-view images on the vehicle coordinate system Σb respectively from the first time-series images and the second time-series images.

Next, the processor 122 finds the first fitted line and the second fitted line respectively from the first plan-view images and the second plan-view images on the vehicle coordinate system Σb.

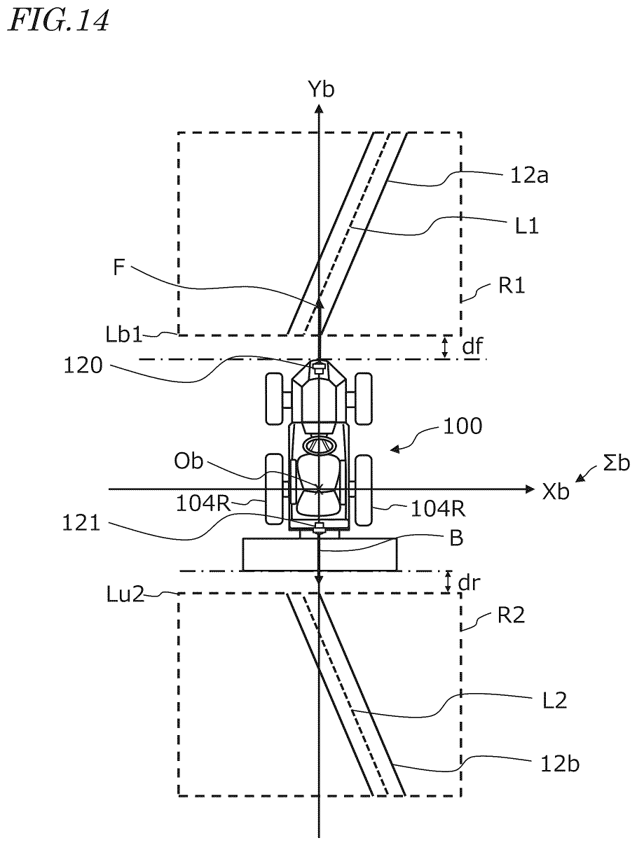

FIG. 14 is a plan view schematically showing positions, in the vehicle coordinate system Σb, of each of a first region of interest R1 and a second region of interest R2 respectively included in the first plan-view images and the second plan-view images, with respect to and the agricultural machine 100. As described above, the first plan-view images and the second plan-view images are associated with the vehicle coordinate system Σb. The first plan-view images include the first region of interest R1, and the second plan-view images include the second region of interest R2. A “region of interest” is a region that is a target of image processing (or image recognition) to be executed by the processor 122. FIG. 14 shows the first region of interest R1 and the second region of interest R2 respectively with dashed-line rectangular regions. In the vehicle coordinate system Σb, the first region of interest R1 is located frontward of the agricultural machine 100, and the second region of interest R2 is located rearward of the agricultural machine 100. On the vehicle coordinate system Σb, the first region of interest R1 does not overlap the second region of interest R2. Note that on the vehicle coordinate system Σb, the first plan-view images and the second plan-view images may partially overlap each other.

A distance df between a straight line Lb1 defining a bottom end of the first region of interest R1 and a front end of the agricultural machine 100, and/or a distance dr between a straight line Lu2 defining a top end of the second region of interest R2 and a rear end of the agricultural machine 100, may each be set to, for example, a range of 1 meter to 2 meters. In the case where an implement is attached to the agricultural machine 100, the rear end of the agricultural machine 100 is located at an outer edge of the implement. A length in the direction of the Xb axis of each of the first region of interest R1 and the second region of interest R2 may be set to, for example, a range of 3 meters to 5 meters, and a length in the direction of the Yb axis of each of the first region of interest R1 and the second region of interest R2 may be set to, for example, a range of 3 meters to 5 meters. From the point of view of generating a local travel path, it is preferred to set the regions of interest to be small.

The processor 122 may adaptably change the size (or the range) of at least one of the first region of interest R1 and the second region of interest R2 in accordance with the travel speed of the agricultural machine 100. The processor 122 may also adaptably change at least one of the distances df and dr described above in accordance with the travel speed of the agricultural machine 100. The processor 122 may set the first region of interest R1 and the second region of interest R2 on the vehicle coordinate system Σb so that as the travel speed of the agricultural machine 100 is higher, the distances df and dr are each shorter and the sizes of the first region of interest R1 and the second region of interest R2 are each smaller. With such settings, the regions of interest having sizes in accordance with the travel speed of the agricultural machine 100 can be set on the vehicle coordinate system Σb. Therefore, the generation of a local travel path may be made easier. Such a local travel path is advantageous for the row-following travel control along the curved crop rows or ridges.

FIG. 12A shows a region R1a in the frontward image 40 with a dashed-line rectangular region. The region R1a corresponds to the first region of interest R1 shown in FIG. 14. FIG. 12B shows a region R2a in the rearward image 41 with a dashed-line rectangular region. The region R2a corresponds to the second region of interest R2 shown in FIG. 14. A first portion 12a of the crop row located in the first region of interest R1 shown in FIG. 14 corresponds to the first portion 12a of the crop row located in the region Ria included in the frontward image 40 shown in FIG. 12A. A second portion 12b of the crop row located in the second region of interest R2 shown in FIG. 14 corresponds to the second portion 12b of the crop row located in the region R2a shown in FIG. 12B.

The processor 122 finds a first fitted line L1 from the first portion 12a located in the first region of interest R1, and finds a second fitted line L2 from the second portion 12b located in the second region of interest R2. The processor 122 finds the fitted lines using, for example, the least squares method. In an example embodiment of the present disclosure, the first fitted line L1 linearly approximates the first portion 12a located in the first region of interest R1, and corresponds to, for example, a line passing the center between edge lines at both of two ends of the first portion 12a. Similarly, the second fitted line L2 linearly approximates the second portion 12b located in the second region of interest R2, and corresponds to, for example, a line passing the center between edge lines at both of two ends of the second portion 12b.

An example of method for detecting a crop row formed in a field will be described. The processor 122 generates an enhanced image, in which the color of the crop row as a target of the detection is enhanced, from time-series images with colors (time-series color images). This enhanced image is generated by, for example, converting RGB values of a one-frame image in the time-series images into a green excess index (ExG). The processor 122 generates, from the enhanced image, a graph plotting the relationship between the ExG and the number of pixels in the image. The processor 122 generates, from this graph, plan-view images as seen from above the ground surface. In the plan-view images, the pixels are classified into first pixels having an index value of the color of the crop row that is equal to, or higher than, a threshold value, and second pixels having an index value of the color of the crop row that is lower than the threshold value. Based on the index value of the first pixels, the processor 122 determines the positions of the edge lines of the crop row. Based on the positions of the edge lines of the crop row, the processor 122 finds the fitted line that linearly approximates the crop row.

An example of method for detecting a ridge formed in a field will be described. From a plurality of images, among the time-series images, captured at different times, the processor 122 finds a first moving amount, in the image plane, of each of a plurality of features by feature matching. The processor 122 further performs perspective projection of each of the plurality of features from the image plane onto a reference plane corresponding to the ground surface, and finds a second moving amount of each of the projected points in the reference plane, based on the first moving amount. Based on the second moving amount, the processor 122 estimates the height of each of the plurality of features from the reference plane to detect the edge lines of the ridge on the ground surface. Based on the positions of the edge lines of the ridge, the processor 122 finds a fitted line that linearly approximates the ridge.

The above-described example of method for detecting the crop row or the ridge is described in detail in International Publication WO2023/276227 by the present Applicant. The entirety of the disclosure of International Publication WO2023/276227 is incorporated herein by reference.

The method for detecting the crop row or the ridge formed in a field is not limited to the above-described example, and may be any of a wide variety of methods using known algorithms. For example, a method for linearly approximating a crop row is described in detail in Japanese Patent No. 2624390 granted to the present Applicant. The entirety of the disclosure of Japanese Patent No. 2624390 is incorporated herein by reference. Japanese Laid-Open Patent Publication No. 2016-describes a method for detecting a line formed by steps of a ridge or grooves. The entirety of the disclosure of Japanese Laid-Open Patent Publication No. 2016-146061 is incorporated herein by reference.

In the above-described example of finding the fitted lines, the time-series images are converted into plan-view images (or overhead-view images), and then a fitted line of the crop row in the vehicle coordinate system is found from the plan-view images. The present disclosure is not limited to this. For example, the processor 122 may find a first pre-fitted line that linearly approximates the first portion of the crop row in a first image coordinate system defining coordinates of pixels in the first time-series images, and may find a second pre-fitted line that linearly approximates the second portion of the crop row in a second image coordinate system defining coordinates of pixels in the second time-series images. The processor 122 may perform coordinate transformation on the first pre-fitted line from the first image coordinate system into the vehicle coordinate system to find the first fitted line in the vehicle coordinate system, and may perform coordinate transformation on the second pre-fitted line from the second image coordinate system into the vehicle coordinate system to find the second fitted line in the vehicle coordinate system. In this manner, a pre-fitted line can be found from the time-series images, and coordinate transformation on the pre-fitted line can be performed from an image coordinate system into the vehicle coordinate system to find a fitted line in the vehicle coordinate system. With this method, the target of the coordinate transformation is not the entirety of the image but is the fitted line. Therefore, the computation load on the processor 122 may be decreased.

In the operation S300, the processor 122 determines the travel path of the agricultural machine 100 based on the first fitted line L1 and the second fitted line L2. Hereinafter, implementation examples 1 and 2 will be described as specific examples of the operation S300.

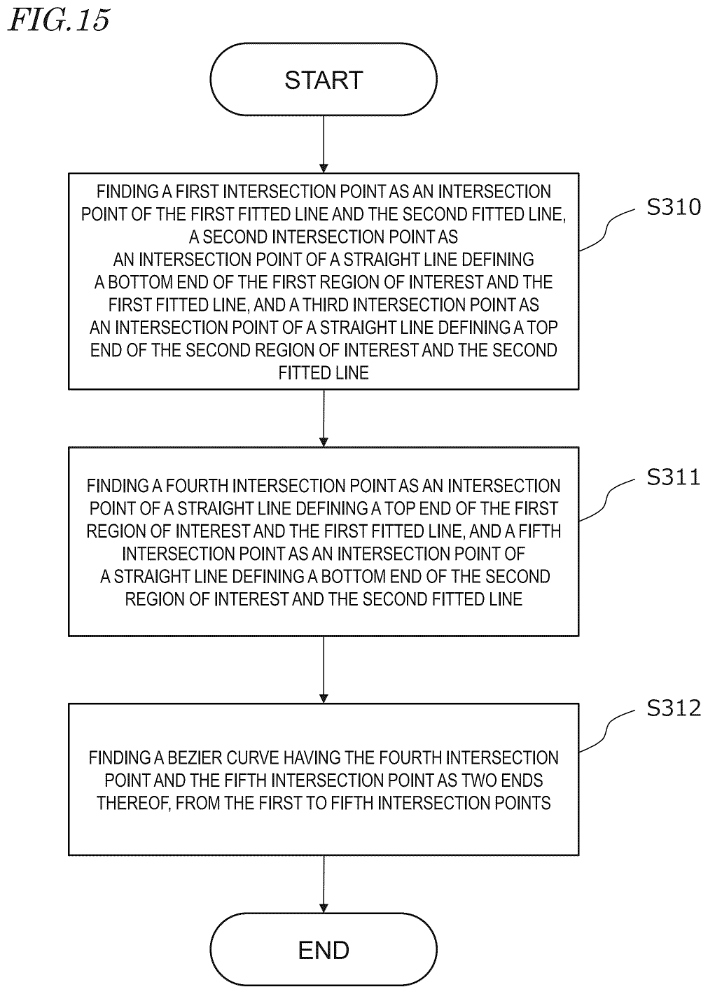

With reference to FIG. 15 through FIG. 19, implementation example 1 of algorithm determining the travel path will be described.

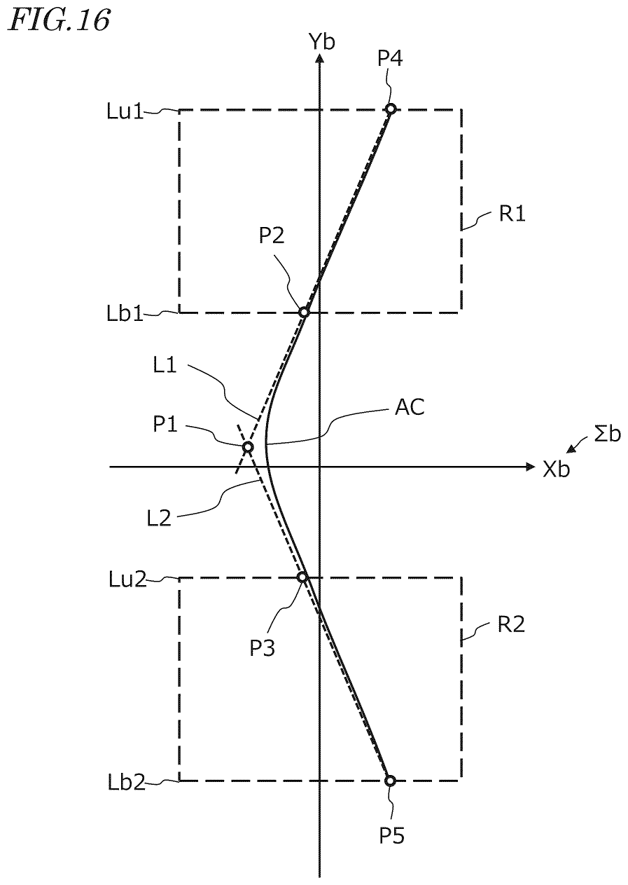

In implementation example 1, the processor 122 finds an approximation curve from a plurality of points on the first fitted line and the second fitted line, and determines the travel path based on the approximation curve. An example of the fitted line is a Bezier curve. FIG. 15 is a flowchart showing an example algorithm in implementation example 1. FIG. 16 is a plan view schematically showing an example of the first fitted line L1, the second fitted line L2 and an approximation curve AC on the vehicle coordinate system Σb.

In an operation S310, based on the first fitted line L1, the second fitted line L2, the first region of interest R1 and the second region of interest R2 in the vehicle coordinate system Σb, the processor 122 finds a plurality of points including a first intersection point P1, which is an intersection point of the first fitted line L1 and the second fitted line L2. From the plurality of points, the processor 122 finds the approximation curve AC. The plurality of points include second and third intersection points P2 and P3 in addition to the first intersection point P1. The second intersection point P2 is an intersection point of the straight line Lb1 defining the bottom end of the first region of interest R1 and the first fitted line L1 in the vehicle coordinate system Σb. The third intersection point P3 is an intersection point of the straight line Lu2 defining the top end of the second region of interest R2 and the second fitted line L2 in the vehicle coordinate system Σb.

The processor 122 can find the approximation curve based on the first, second and third intersection points P1 through P3. Note that in implementation example 1, the processor 122 finds other points on the first fitted line and the second fitted line in order to improve the computation precision of the approximation curve.

In an operation S311, the processor 122 further finds a fourth intersection point P4 and a fifth intersection point P5. In other words, the plurality of points in implementation example 1 further include the fourth and fifth intersection points P4 and P5 in addition to the first, second and third intersection points P1 through P3. The fourth intersection point P4 is an intersection point of a straight line Lu1 defining a top end of the first region of interest R1 and the first fitted line L1 in the vehicle coordinate system Σb. The fifth intersection point P5 is an intersection point of a straight line Lb2 defining a bottom end of the second region of interest R2 and the second fitted line L2. The first, second, third, fourth and fifth intersection points P1 through P5 are each located at a pixel position represented by coordinates in the vehicle coordinate system Σb.

In an operation S312, the processor 122 finds the approximation curve from the first, second, third, fourth and fifth intersection points P1 through P5. The processor 122 in implementation example 1 finds a Bezier curve having the fourth intersection point P4 and the fifth intersection point P5 as two ends thereof. Specifically, the processor 122 finds the Bezier curve from equation 6 below. Here, P(t) represents the equation of the curve, B represents the control point, and t represents the parameter. Equation 7 shows the Bernstein basis polynomial. The first, second, third, fourth and fifth intersection points P1 through P5 are each a control point. FIG. 16 shows an example of Bezier curve found from these control points. Note that the approximation curve according to an example embodiment of the present disclosure is not limited to the Bezier curve, and may be a curve such as, for example, a spline curve.

$$P ( t ) = {\sum }_{i = 0}^{N - 1} {B}_{i} {J}_{N - 1 , i} ( t ) \qquad [ eq . 6 ]$$

$${J}_{N , i} ( t ) = ( \begin{matrix}N \\ i\end{matrix} ) {{t}^{i} ( 1 - t )}^{N - 1} \qquad [ eq . 7 ]$$

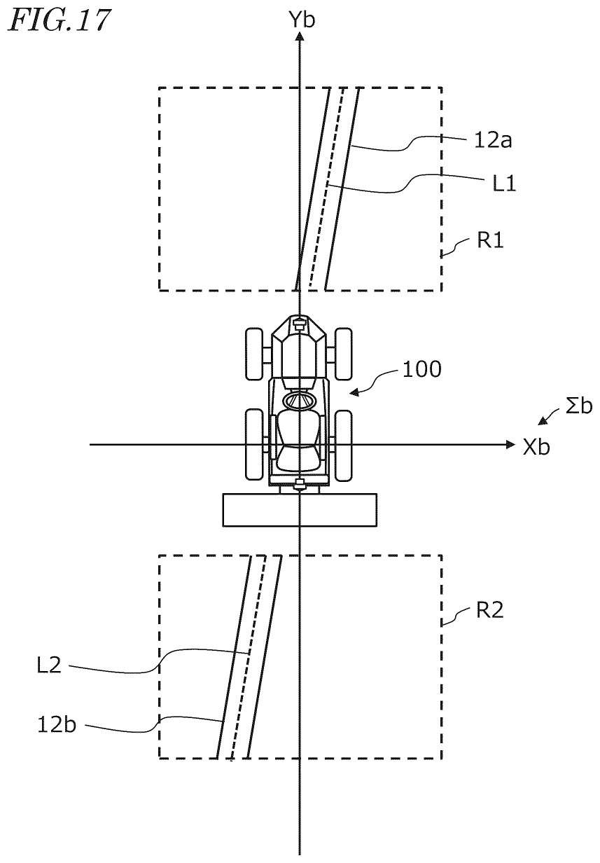

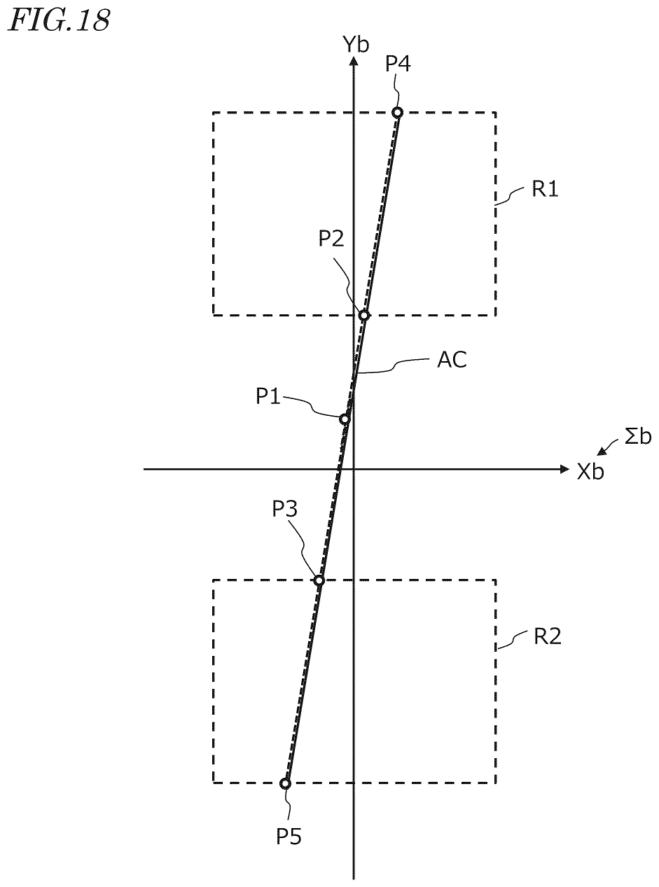

FIG. 17 is a plan view schematically showing the first portion 12a and the second portion 12b respectively located in the first region of interest R1 and the second region of interest R2 in the vehicle coordinate system Σb while the agricultural machine 100 is traveling along a straight crop row. FIG. 18 is a plan view schematically showing an example of the control points and an example of the approximation curve on the vehicle coordinate system Σb. In implementation example 1, even in the case where the agricultural machine 100 travels along the straight crop rows as shown in FIG. 5, the travel path can be determined. The processor 122 finds the first fitted line L1 that linearly approximates the first portion 12a of the straight crop row and the second fitted line L2 that linearly approximates the second portion 12b of the straight crop row.

The processor 122 finds the first, second, third, fourth and fifth intersection points P1 through P5, which are control points, based on the first fitted line L1, the second fitted line L2, the first region of interest R1 and the second region of interest R2 on the vehicle coordinate system Σb. In the case where the agricultural machine 100 travels along the straight crop row, as shown in FIG. 18, the first, second, third, fourth and fifth intersection points P1 through P5 are arranged generally straight. Therefore, the approximation curve AC is extremely close to being straight. The processor 122 can find the approximation curve AC from the first, second, third, fourth and fifth intersection points P1 through P5.

In this manner, the processor 122 determines the approximation curve AC found on the vehicle coordinate system Σb as the travel path. The processor 122 generates the travel path while finding an approximation curve at an interval of, for example, 200 milliseconds.

The controller 124 is configured or programmed to control the travel of the agricultural machine 100 based on the travel path determined by the processor 122. In other words, the controller 124 is configured or programmed to control the travel of the agricultural machine 100 based on the travel path set on the vehicle coordinate system Σb.

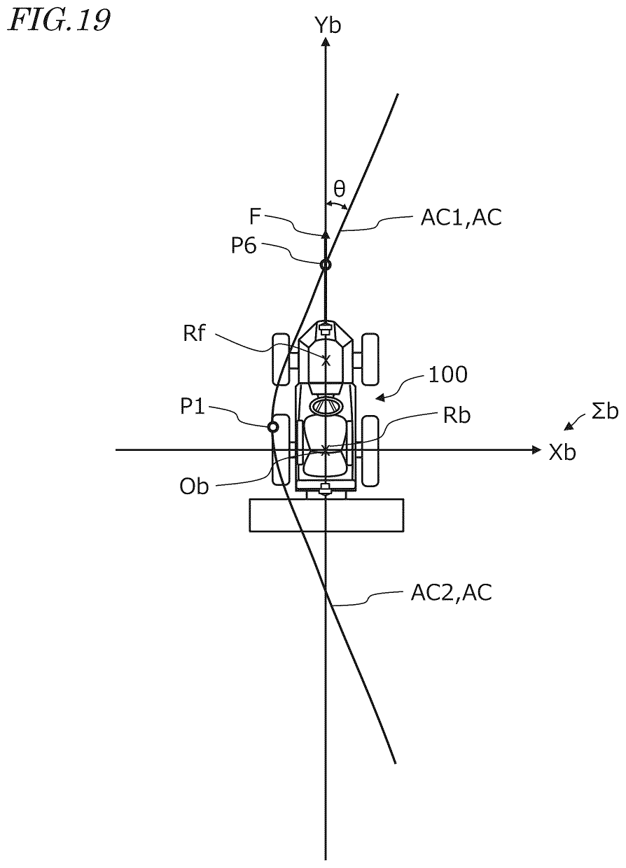

FIG. 19 is a plan view provided to describe the row-following travel control along the travel path set on the vehicle coordinate system Σb. The approximation curve AC (that is, the travel path) on the vehicle coordinate system Σb includes a first curved portion AC1 located on the side of the first region of interest R1 with respect to the first intersection point P1 and a second curved portion AC2 located on the side of the second region of interest R2 with respect to the first intersection point P1. The origin Ob of the vehicle coordinate system Σb in an example embodiment of the present disclosure is on the rear wheel axis of the agricultural machine 100 in a plan view as seen from above the ground surface on which the agricultural machine 100 travels. In the present disclosure, the origin Ob, of the vehicle coordinate system Σb, on the rear wheel axis may be referred to as a “rear reference point Rb”.

The controller 124 is configured or programmed to control the travel of the agricultural machine 100 based on the deviation between the origin Ob of the vehicle coordinate system Σb (or the rear reference point Rb) and the second curved portion AC2. In other words, the controller 124 is configured or programmed to control the position of the agricultural machine 100 so that the origin Ob of the vehicle coordinate system Σb approaches the second curved portion AC2. Specifically, the controller 124 is configured or programmed to control the position of the agricultural machine 100 so as to minimize the distance from the origin Ob of the vehicle coordinate system Σb to a tangent of a given point among a group of points on the second curved portion AC2, that is, so as to minimize the length of the vertical line from the origin Ob to the tangent.

The controller 124 may control the travel of the agricultural machine 100 further based on the heading deviation between the direction in which a tangent of a given point among the group of points on the first curved portion AC1 extends and the orientation of the agricultural machine 100. For example, the controller 124 is configured or programmed to control the pose of the agricultural machine 100 so as to minimize the angle 9 made by a tangent of the first curved portion AC1 at a sixth intersection point P6, at which the first curved portion AC1 and the Yb axis of the vehicle coordinate system Σb cross each other, and arrow F representing the forward traveling direction for the agricultural machine 100.

Conventionally, a frontward image acquired by an imager that captures an image of an area frontward of the agricultural machine 100 is processed to detect a crop row or a ridge, and the position of the crop row or the ridge is estimated based on the results of detection of the crop row or the ridge. Based on the results of estimation, the travel path is determined. However, in the case where the crop row or the ridge includes a curved portion, such a method makes it difficult to precisely control the steering and travel of the agricultural machine 100 along such a curved crop row or ridge. In addition, in the case of the curved crop row or ridge, such a method makes it difficult to apply an automatic steering technique using a positioning system such as GNSS or the like.

According to implementation example 1, a frontward image and a rearward image acquired by two imagers respectively capturing the images of an area frontward of the agricultural machine 100 and an area rearward of the agricultural machine 100 are processed, so that the precision of estimation of the position of the crop row, which is a target of following, may be improved. As a result, even in a field where curved crop rows or ridges are formed, the steering and the travel of the agricultural machine 100 along such curved crop rows or ridges can be precisely controlled. Such row-following travel control allows precise automatic steering to be performed in an environment where an automatic steering technique using the positioning system such as GNSS or the like is not easily applicable.

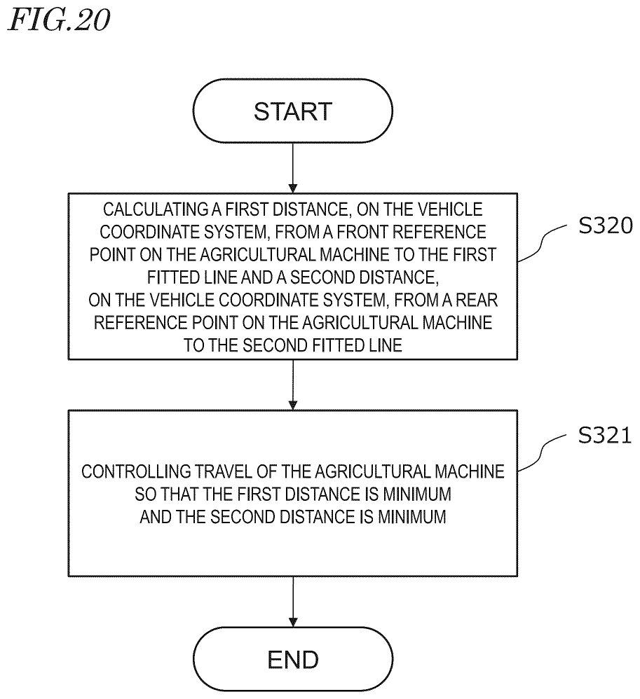

With reference to FIG. 20 through FIG. 22, implementation example 2 of algorithm determining the travel path will be described.

Unlike in implementation example 1, the processor 122 in implementation example 2 does not generate the approximation curve from the first and second fitted lines. Instead, the controller 124 directly controls the travel of the agricultural machine 100 based on the first and second fitted lines found by the processor 122. Therefore, in implementation example 2, the first and second fitted lines will be referred to as “travel paths”. As can be seen, the “travel path” according to an example embodiment of the present disclosure encompasses the first and second fitted lines in a broad sense.

The controller 124 in implementation example 2 controls the travel of the agricultural machine 100 based on a first distance, on the vehicle coordinate system Σb, from a front reference point on the agricultural machine 100 to the first fitted line and a second distance, on the vehicle coordinate system Σb, from a rear reference point on the agricultural machine 100 to the second fitted line.

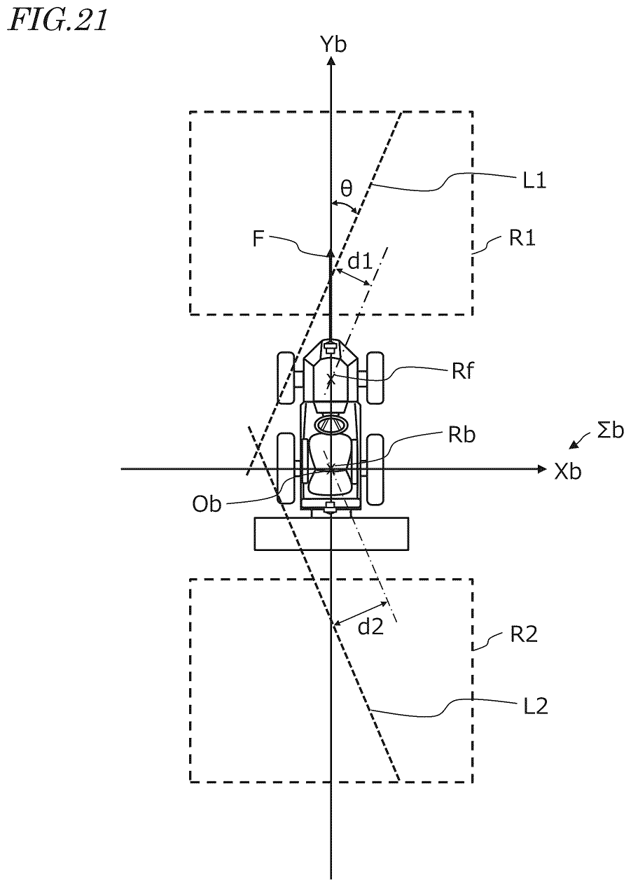

FIG. 20 is a flowchart showing an example algorithm in implementation example 2. FIG. 21 is a plan view schematically showing an example of positions of the first fitted line L1, the second fitted line L2, a front reference point Rf and a rear reference point Rb on the vehicle coordinate system Σb, with respect to the agricultural machine 100.

In an operation S320, the controller 124 independently, or the controller 124 and the processor 122 in cooperation with each other, find a first distance d1, on the vehicle coordinate system Σb, from the front reference point Rf on the agricultural machine 100 to the first fitted line L1 and a distance d2, on the vehicle coordinate system Σb, from the rear reference point Rb on the agricultural machine 100 to the second fitted line L2. The distance from such a reference point to such a fitted line corresponds to the length of the vertical line from the reference point to the fitted line.

As shown in FIG. 21, in an example embodiment of the present disclosure, in a plan view as seen from above the ground surface on which the agricultural machine 100 travels, the front reference point Rf is on a front wheel axis of the agricultural machine 100, whereas the rear reference point Rb is on the rear wheel axis of the agricultural machine 100. Note that the front reference point Rf and the rear reference point Rb are not limited to being located at such positions.

In an operation S321, the controller 124 is configured or programmed to control the travel of the agricultural machine 100 so that the first distance d1 is minimum and the second distance d2 is minimum. In implementation example 2, the first distance d1 and the second distance d2 are each represented as a signed distance that defines the distance from the point to the straight line. The controller 124 estimates the heading deviation between the first fitted line L1 and the orientation of the agricultural machine 100 based on the first distance d1 with a sign, and also estimates the positional deviation between the rear reference point Rb and the second fitted line L2 based on the second distance d2 with a sign.

The controller 124 estimates the heading deviation of the agricultural machine 100 based on the magnitude and the sign of the first distance d1. The heading deviation is given by, for example, the angle 9 made by the forward traveling direction for the agricultural machine 100 (direction of arrow F) and the first fitted line L1. In the example shown in FIG. 21, the direction of arrow F matches the direction of the Yb axis in the vehicle coordinate system Σb. The angle 9 is an angle with, for example, the clockwise direction being a positive direction. The controller 124 estimates the positional deviation between the rear reference point Rb and the second fitted line L2 based on the magnitude and the sign of the second distance d2. In other words, the controller 124 may estimate the deviation between the position of the agricultural machine 100 and the position of the second fitted line L2 based on the magnitude and the sign of the second distance d2. Use of a signed distance allows the offset in the direction and in the position of the agricultural machine 100 with respect to the travel path to be estimated with relatively high precision. In this manner, the controller 124 is configured or programmed to control the travel of the agricultural machine 100 so that the heading deviation and the positional deviation are each decreased.

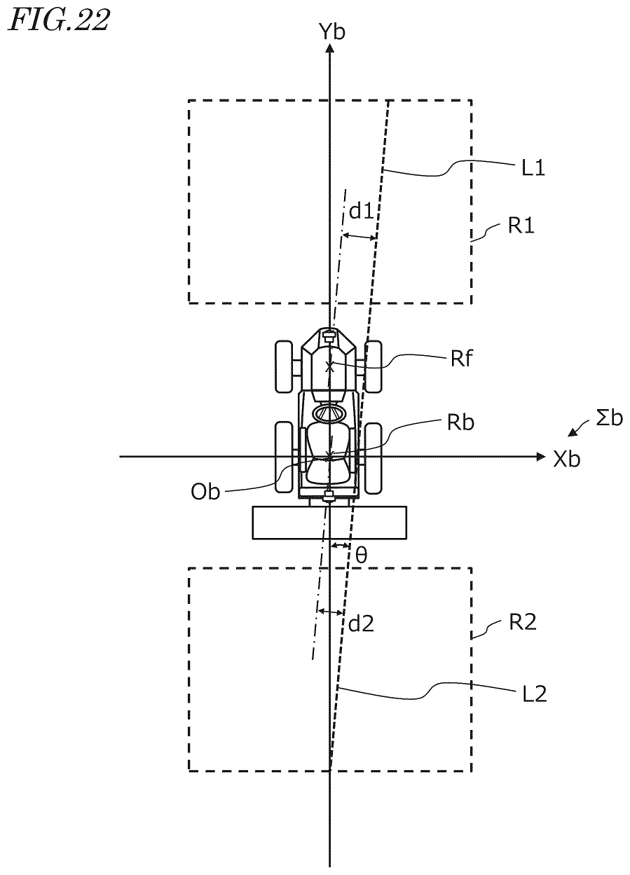

FIG. 22 is a plan view schematically showing the first region of interest R1, the second region of interest R2, the first fitted line L1 and the second fitted line L2 on the vehicle coordinate system Σb while the agricultural machine 100 is traveling along a straight crop row. In implementation example 2, even in the case where the agricultural machine 100 travels along the straight crop rows as shown in FIG. 5, the travel of the agricultural machine 100 can be controlled. The processor 122 finds the first fitted line L1 that linearly approximates the first portion of the straight crop row and the second fitted line L2 that linearly approximates the second portion of the straight crop row.

In the case where the agricultural machine 100 travels along a straight crop row, as shown in FIG. 22, the first and second fitted lines L1 and L2 are arranged generally straight. The controller 124 is configured or programmed to control the travel of the agricultural machine 100 so that the first distance d1 is minimum and the second distance d2 is minimum. As described above, the controller 124 estimates the heading deviation of the agricultural machine 100 based on the magnitude and the sign of the first distance d1, and estimates the positional deviation between the rear reference point Rb and the second fitted line L2 based on the magnitude and the sign of the second distance d2. In this manner, the agricultural machine 100 can travel along such a straight crop row.

According to implementation example 2, a frontward image and a rearward image acquired by two imagers respectively capturing the images of an area frontward of the agricultural machine 100 and an area rearward of the agricultural machine 100 are processed, so that the precision of estimation of the position of the crop row, which is a target of following, may be improved. As a result, even in a field where curved crop rows or ridges are formed, the steering and the travel of the agricultural machine 100 along such curved crop rows or ridges can be precisely controlled. Recently, an agricultural machine having a function of allowing the agricultural machine to travel straight in parallel to a reference line that connects a start point and an end point to each other has been developed. The algorithm according to implementation example 2 is easily implemented for such a function and is useful.

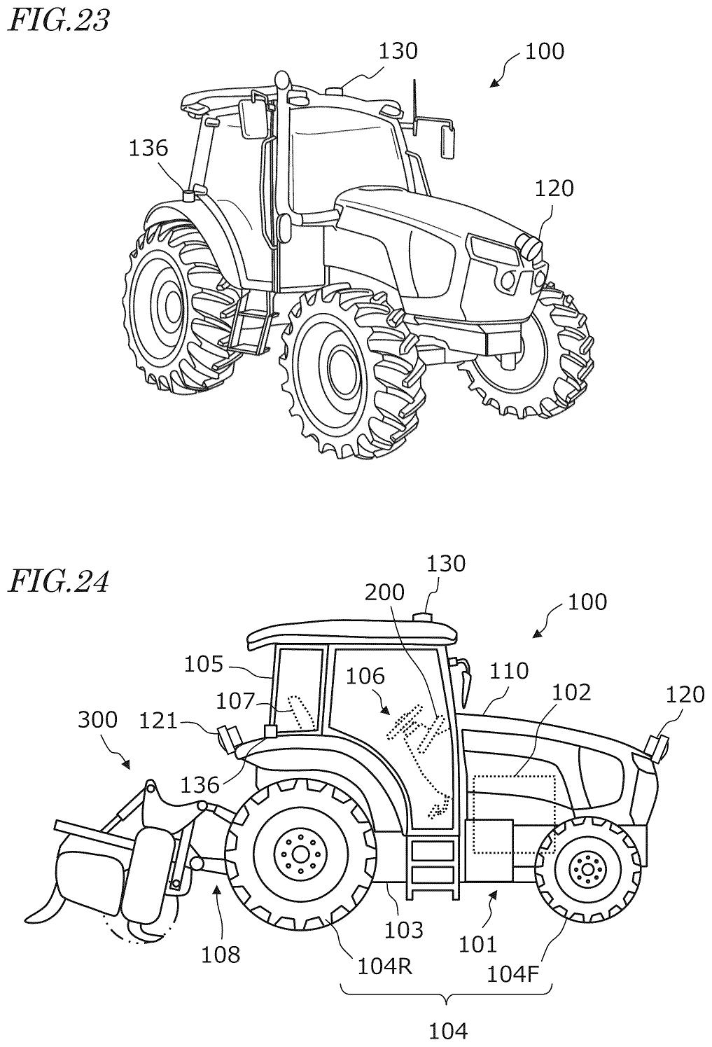

FIG. 23 is a perspective view showing an example of external appearance of the agricultural machine 100 according to an example embodiment of the present disclosure. FIG. 24 is a side view schematically showing an example of the agricultural machine 100 to which the implement 300 is attached. The agricultural machine 100 according to an example embodiment of the present disclosure is an agricultural tractor (work vehicle) having the implement 300 attached thereto. The agricultural machine 100 is not limited to a tractor, or does not need to have the implement 300 attached thereto. The travel control technique according to an example embodiment of the present disclosure can exhibit excellent effects when being used in small-sized crop management machines and vegetable transplanters that may be used for tasks associated with the interridge land, such as, for example, ridge making, intertillage, ridging, weeding, side dressing, and preventive pest control.

The agricultural machine 100 according to an example embodiment of the present disclosure includes the first and second imagers 120 and 121, a positioning device 130, and an obstacle sensor(s) 136. Although one obstacle sensor 136 is illustrated in FIG. 24, obstacle sensors 136 may be provided at a plurality of positions of the agricultural machine 100.

As shown in FIG. 24, the agricultural machine 100 includes the vehicle body 110, a prime mover (engine) 102, and a transmission 103. On the vehicle body 110, the tires (wheels) 104 and a cabin 105 are provided. The tires 104 include the pair of the front wheels 104F and the pair of the rear wheels 104R. Inside the cabin 105, a driver's seat 107, a steering device 106, an operational terminal 200, and switches for manipulation are provided. One of the front wheels 104F or the rear wheels 104R may be crawlers instead of the tires. The agricultural machine 100 may be a four-wheel drive vehicle including the four wheels 104 as driving wheels, or a two-wheel drive vehicle including the pair of front wheels 104F or the pair of rear wheels 104R as driving wheels.

The positioning device 130 in an example embodiment of the present disclosure includes a GNSS receiver. The GNSS receiver includes an antenna to receive a signal(s) from a GNSS satellite (s) and a processing circuit to determine the position of the agricultural machine 100 based on the signal(s) received by the antenna. The positioning device 130 receives a GNSS signal(s) transmitted from a GNSS satellite(s), and performs positioning on the basis of the GNSS signal(s). GNSS is a general term for satellite positioning systems, such as GPS (Global Positioning System), QZSS (Quasi-Zenith Satellite System, e.g., MICHIBIKI), GLONASS, Galileo, BeiDou, and the like. Although the positioning device 130 in an example embodiment of the present disclosure is disposed above the cabin 105, it may be disposed at any other position.

Furthermore, the positioning device 130 may complement the position data by using a signal from an IMU. The IMU can measure tilts and minute motions of the agricultural machine 100. By complementing the position data based on the GNSS signal using the data acquired by the IMU, the positioning performance can be improved.

In the examples shown in FIGS. 23 and 24, the obstacle sensor(s) 136 is provided at the rear of the vehicle body 110. The obstacle sensor(s) 136 may be disposed at any other position than the rear of the vehicle body 110. For example, one or more obstacle sensors 136 may be disposed at any position at the sides of the vehicle body 110, the front of the vehicle body 110, and the cabin 105. The obstacle sensor(s) 136 detects objects around the agricultural machine 100. Each obstacle sensor 136 may include a laser scanner or an ultrasonic sonar, for example. In the case where an obstacle exists at a position closer than a predetermined distance from the obstacle sensor 136, the obstacle sensor 136 outputs a signal indicating the presence of the obstacle. A plurality of obstacle sensors 136 may be provided at different positions of the body of the agricultural machine 100. For example, a plurality of laser scanners and a plurality of ultrasonic sonars may be disposed at different positions of the body. Providing such a large number of obstacle sensors 136 can reduce blind spots in monitoring obstacles around the agricultural machine 100.

The prime mover 102 may be a diesel engine, for example. Instead of a diesel engine, an electric motor may be used. The transmission 103 can change the propulsion and moving speed of the agricultural machine 100 through a speed changing mechanism. The transmission 103 can also switch between forward travel and backward travel of the agricultural machine 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as a “steering angle”) can cause a change in the forward traveling direction for the agricultural machine 100. The steering angle of the front wheels 104F can be changed by manipulation on the steering wheel. The power steering device includes a hydraulic device or an electric motor to supply an assisting force for changing the steering angle of the front wheels 104F. When automatic steering is performed, under the control of a controller disposed in the agricultural machine 100, the steering angle is automatically adjusted by the power of the hydraulic device or the electric motor.

A linkage device 108 is provided at the rear of the vehicle body 110. The linkage device 108 may include, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the agricultural machine 100. The linkage device 108 is able to raise or lower the three-point linkage device with, for example, a hydraulic device, thus controlling the position or pose of the implement 300. Moreover, motive power can be sent from the agricultural machine 100 to the implement 300 via the universal joint. While towing the implement 300, the agricultural machine 100 allows the implement 300 to perform a predetermined task. The linkage device may be provided frontward of the vehicle body 110. In that case, the implement may be connected frontward of the agricultural machine 100.

The implement 300 shown in FIG. 24 is a rotary cultivator, for example. The implement 300 to be towed by, or attached to, a tractor or other work vehicles when traveling in a manner of following rows may be any kind, so long as it is used in operations associated with the interridge land, such as ridge making, intertillage, ridging, weeding, side dressing, and preventive pest control.

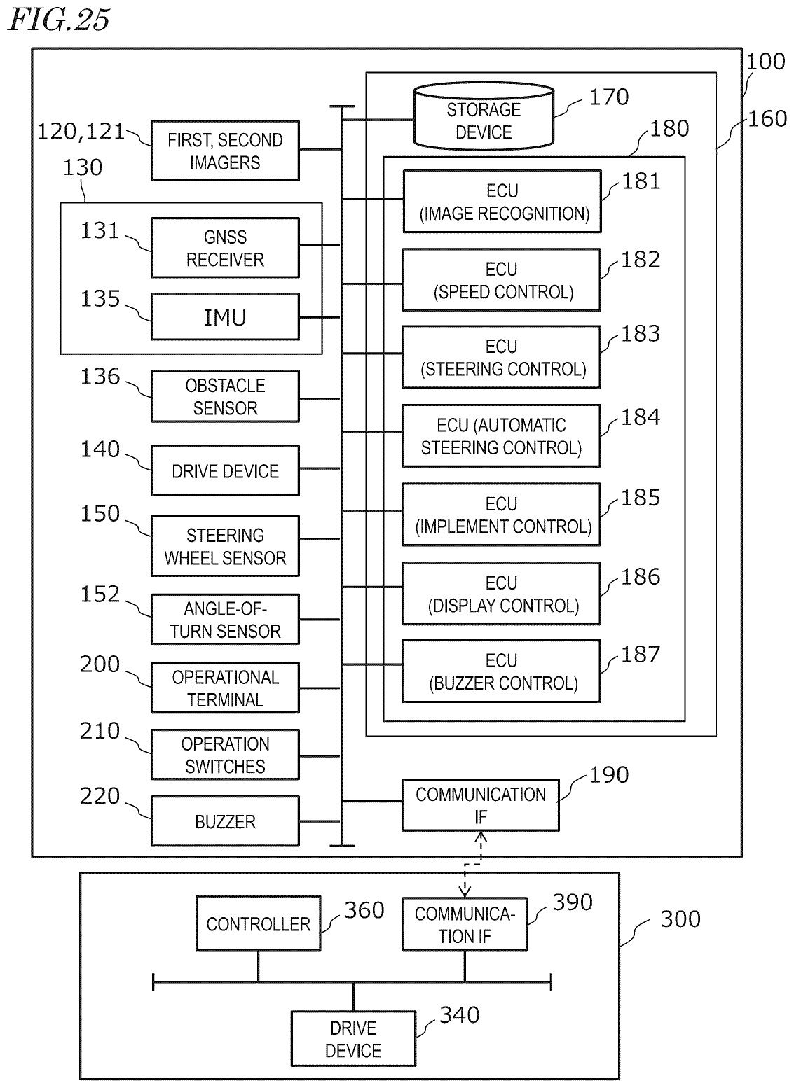

FIG. 25 is a block diagram showing an example of schematic configuration of the agricultural machine 100 and the implement 300. The agricultural machine 100 and the implement 300 can communicate with each other via a communication cable that is included in the linkage device 108.

In addition to the first imager 120, the second imager 121, the positioning device 130, the obstacle sensor 136 and the operational terminal 200, the agricultural machine 100 in the example of FIG. 25 includes a drive device 140, a steering wheel sensor 150, an angle-of-turn sensor 152, a control system 160, a communication interface (IF) 190, operation switches 210, and a buzzer 220. The positioning device 130 includes a GNSS receiver 131 and an IMU 135. The control system 160 includes a storage device 170 and a controller 180. The controller 180 includes a plurality of electronic control units (ECU) 181 to 186. The implement 300 includes a drive device 340, a controller 380, and a communication interface (IF) 390. Note that FIG. 25 shows component elements which are relatively closely related to the operation of automatic steering or self-driving by the agricultural machine 100, while other component elements are omitted from illustration.

The positioning device 130 performs positioning of the agricultural machine 100 by utilizing GNSS. In the case where the positioning device 130 includes an RTK receiver, not only GNSS signals transmitted from multiple GNSS satellites, but also a correction signal that is transmitted from a reference station is used. The reference station may be disposed around the field that is traveled by the agricultural machine 100 (e.g., at a position within 10 km of the agricultural machine 100). The reference station generates a correction signal based on the GNSS signals received from the multiple GNSS satellites, and transmits the correction signal to the positioning device 130. The GNSS receiver 131 in the positioning device 130 receives the GNSS signals transmitted from the multiple GNSS satellites. Based on the GNSS signals and the correction signal, the positioning device 130 calculates the position of the agricultural machine 100, thus achieving positioning. Use of the RTK-GNSS enables positioning with an accuracy on the order of several centimeters of errors, for example. Positional information, including latitude, longitude and altitude information, is acquired through the highly accurate positioning by the RTK-GNSS. Note that the positioning method is not limited to the RTK-GNSS, but any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System).

The IMU 135 includes a 3-axis accelerometer and a 3-axis gyroscope. The IMU 135 may include a direction sensor such as a 3-axis geomagnetic sensor. The IMU 135 functions as a motion sensor which can output signals representing parameters such as acceleration, velocity, displacement, and pose of the agricultural machine 100. Based not only on the GNSS signals and the correction signal but also on a signal that is output from the IMU 135, the positioning device 130 can estimate the position and orientation of the agricultural machine 100 with a higher accuracy. The signal that is output from the IMU 135 may be used for the correction or complementation of the position that is calculated based on the GNSS signals and the correction signal. The IMU 135 outputs a signal more frequently than the GNSS signals. Utilizing this highly frequent signal allows the position and orientation of the agricultural machine 100 to be measured more frequently (e.g., about 10 Hz or above). Instead of the IMU 135, a 3-axis accelerometer and a 3-axis gyroscope may be separately provided. The IMU 135 may be provided as a separate device from the positioning device 130.

In addition to the GNSS receiver 131 and the IMU 135, the positioning device 130 may include other kinds of sensors. Depending on the environment that is traveled by the agricultural machine 100, it is possible to estimate the position and orientation of the agricultural machine 100 with a high accuracy based on data from such sensors.

For example, the drive device 140 includes various devices that are needed for the travel of the agricultural machine 100 and the driving of the implement 300, e.g., the aforementioned prime mover 102, the transmission 103, a differential including a locking differential mechanism, the steering device 106, and the linkage device 108. The prime mover 102 includes an internal combustion engine such as, for example, a diesel engine. Instead of, or in addition to, the internal combustion engine, the drive device 140 may include an electric motor that is dedicated to traction purposes.

The steering wheel sensor 150 measures the angle of rotation of the steering wheel of the agricultural machine 100. The angle-of-turn sensor 152 measures the angle of turn of the front wheels 104F, which are the wheels responsible for steering. Measurement values provided by the steering wheel sensor 150 and the angle-of-turn sensor 152 are used for the steering control by the controller 180.

The storage device 170 includes one or more storage media such as a flash memory or a magnetic disc. The storage device 170 stores various data that is generated by the sensors and the controller 180. The data that is stored by the storage device 170 may include map data in the environment that is traveled by the agricultural machine 100, and data on a travel path of automatic steering. The storage device 170 also stores a computer program(s) to cause the ECUs in the controller 180 to perform various operations described below. Such a computer program(s) may be provided for the agricultural machine 100 via a storage medium (e.g., a semiconductor memory, an optical disc or the like) or through telecommunication lines (e.g., the Internet). Such a computer program(s) may be marketed as commercial software.

The controller 180 includes a plurality of ECUs. The plurality of ECUs include an ECU 181 for image recognition, an ECU 182 for speed control, an ECU 183 for steering control, an ECU 184 for automatic steering control, an ECU 185 for implement control, an ECU 186 for display control, and an ECU 187 for buzzer control. The ECU 181 for image recognition is configured or programmed to function as a processor of the travel control system. The ECU 182 is configured or programmed to control the prime mover 102, the transmission 103, and brakes included in the drive device 140, thus controlling the speed of the agricultural machine 100. The ECU 183 is configured or programmed to control the hydraulic device or the electric motor included in the steering device 106 based on a measurement value of the steering wheel sensor 150, thus controlling the steering of the agricultural machine 100.

The ECU 184 is configured or programmed to function as a controller of the travel control system. The ECU 184 is configured or programmed to execute computations and controls to realize row-following travel, based on an output from the ECU 181 for image recognition. The ECU 184 is configured or programmed to execute computations and controls to achieve automatic steering driving, based on signals which are output from the positioning device 130, the steering wheel sensor 150, and the angle-of-turn sensor 152. During the row-following travel or the automatic steering driving, the ECU 184 sends the ECU 183 a command to change the steering angle. In response to this command, the ECU 183 is configured or programmed to control the steering device 106 to change the steering angle.

In order to cause the implement 300 to perform a desired operation, the ECU 185 is configured or programmed to control the operation of the linkage device 108. Also, the ECU 185 generates a signal to control the operation of the implement 300, and transmits this signal from the communication IF 190 to the implement 300. The ECU 186 is configured or programmed to control displaying on the operational terminal 200. For example, the ECU 186 causes a display device of the operational terminal 200 to present various indications, e.g., a map of the field, detected crop rows or ridges, the position and the travel path of the agricultural machine 100 in the map, pop-up notifications, and setting screens. The ECU 187 is configured or programmed to control outputting of alarm sounds by the buzzer 220.

Through the action of these ECUs, the controller 180 realizes driving via manual steering or automatic steering. During usual automatic steering driving, the controller 180 is configured or programmed to control the drive device 140 based on the position of the agricultural machine 100 as measured or estimated by the positioning device 130 and the travel path stored on the storage device 170. As a result, the controller 180 causes the agricultural machine 100 to travel along the travel path. By contrast, in a row-following control mode where travel is done along the rows, the ECU 181 for image recognition finds, from a detected crop row or ridge, the fitted line of the crop row or ridge, and generates a travel path based on the fitted line. The controller 180 performs an operation in accordance with this travel path.

The plurality of ECUs included in the controller 180 may communicate with one another according to a vehicle bus standard such as a CAN (Controller Area Network). Although the ECUs 181 to 187 are illustrated as individual blocks in FIG. 25, each of these functions may be implemented by a plurality of ECUs. Alternatively, an onboard computer that integrates at least a portion of the functions of the ECUs 181 to 187 may be provided. The controller 180 may include ECUs other than the ECUs 181 to 187, and any number of ECUs may be provided in accordance with functionality. Each ECU includes a control circuit including one or more processors.

The communication IF 190 is a circuit that performs communications with the communication IF 390 of the implement 300. The communication IF 190 performs exchanges of signals complying with an ISOBUS standard such as, for example, ISOBUS-TIM between the communication IF 190 itself and the communication IF 390 of the implement 300. This causes the implement 300 to perform a desired operation, or allows information to be acquired from the implement 300. The communication IF 190 may communicate with an external computer via a wired or wireless network. The external computer may be a server computer in a farming support system which centralizes management of information concerning fields by using a cloud, and assists in agriculture by utilizing the data on the cloud, for example.

The operational terminal 200 is a terminal for the operator to perform a manipulation related to the travel of the agricultural machine 100 and the operation of the implement 300, and may also be referred to as a virtual terminal (VT). The operational terminal 200 may include a display device such as a touch screen panel, and/or one or more buttons. By manipulating the operational terminal 200, the operator can perform various manipulations of, for example, switching ON/OFF the automatic steering mode, switching ON/OFF the cruise control, setting an initial position of the agricultural machine 100, setting a travel path, recording or editing a map, switching between 2WD and 4WD, switching ON/OFF the locking differential, and switching ON/OFF the implement 300. At least a portion of these manipulations can also be realized by manipulating the operation switches 210. Display on the operational terminal 200 is controlled by the ECU 186.

The buzzer 220 is an audio output device to present an alarm sound for alerting the operator of an abnormality. For example, during automatic steering driving, the buzzer 220 presents an alarm sound when the agricultural machine 100 deviates from the travel path by a predetermined distance or more. Instead of the buzzer 220, a loudspeaker of the operational terminal 200 may provide a similar function. The buzzer 220 is controlled by the ECU 186.

The drive device 340 in the implement 300 performs an operation necessary for the implement 300 to perform a predetermined task. The drive device 340 includes devices adapted to the intended use of the implement 300, e.g., a hydraulic device, an electric motor, or a pump. The controller 380 is configured or programmed to control the operation of the drive device 340. In response to a signal that is transmitted from the agricultural machine 100 via the communication IF 390, the controller 380 causes the drive device 340 to perform various operations. Moreover, a signal that is in accordance with the state of the implement 300 may be transmitted from the communication IF 390 to the agricultural machine 100.

In the above-described example embodiments, the agricultural machine 100 may be an unmanned work vehicle which performs self-driving. In that case, component elements which are only required for human driving, e.g., the cabin, the driver's seat, the steering wheel, and the operational terminal, do not need to be provided in the agricultural machine 100. The unmanned work vehicle may perform operations similar to the operations in the above-described example embodiment via autonomous driving, or by remote manipulations by an operator.

A system that provides the various functions according to the example embodiments can be mounted on an agricultural machine lacking such functions as an add-on. Such a system may be manufactured and sold independently from the agricultural machine. A computer program for use in such a system may also be manufactured and sold independently from the agricultural machine. The computer program may be provided as being stored on a computer-readable, non-transitory storage medium, for example. The computer program may also be provided through downloading via telecommunication lines (e.g., the Internet).

Example embodiments of the present disclosure can be applied to agricultural machines, such as, for example, vehicles for crop management, vegetable transplanters, or tractors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A travel control system, comprising:
a processor configured or programmed to:
acquire first time-series images including a first portion of a crop row or a ridge in a field from a first imager attached to a work vehicle for agriculture so as to face in a first direction;
acquire second time-series images including a second portion of the crop row or the ridge from a second imager attached to the work vehicle so as to face in a second direction different from the first direction; and
execute image processing on the first time-series images and the second time-series images to determine a travel path of the work vehicle; and
a controller configured or programmed to control travel of the work vehicle based on the travel path; wherein
the processor is configured or programmed to:
find a first fitted line of the first portion in a vehicle coordinate system fixed to the work vehicle, based on the first time-series images;
find a second fitted line of the second portion in the vehicle coordinate system, based on the second time-series images; and
determine the travel path based on the first fitted line and the second fitted line.

2. The travel control system of claim 1, wherein the processor is configured or programmed to find an approximation curve from a plurality of points on the first fitted line and the second fitted line to determine the travel path based on the approximation curve.

3. The travel control system of claim 1, wherein the processor is configured or programmed to:
find a first pre-fitted line that linearly approximates the first portion in a first image coordinate system defining coordinates of pixels of the first time-series images;
find a second pre-fitted line that linearly approximates the second portion in a second image coordinate system defining coordinates of pixels of the second time-series images;
perform coordinate transformation on the first pre-fitted line from the first image coordinate system into the vehicle coordinate system to find the first fitted line in the vehicle coordinate system; and
perform coordinate transformation on the second pre-fitted line from the second image coordinate system into the vehicle coordinate system to find the second fitted line in the vehicle coordinate system.

4. The travel control system of claim 1, wherein the processor is configured or programmed to:
transform the first time-series images and the second time-series images respectively into first plan-view images and second plan-view images as seen from above a ground surface on which the work vehicle travels; and
find the first fitted line and the second fitted line respectively from the first plan-view images and the second plan-view images.

5. The travel control system of claim 4, wherein
the first plan-view images include a first region of interest as a target of the image processing to be executed by the processor;
the first plan-view images include a second region of interest as a target of the image processing to be executed by the processor; and
the processor is configured or programmed to find the first fitted line from the first portion located in the first region of interest, and find the second fitted line from the second portion located in the second region of interest.

6. The travel control system of claim 5, wherein the processor is configured or programmed to change a size of at least one of the first region of interest and the second region of interest in accordance with a travel speed of the work vehicle.

7. The travel control system of claim 5, wherein the first region of interest does not overlap the second region of interest on the vehicle coordinate system.

8. The travel control system of claim 5, wherein the processor is configured or programmed to find the approximation curve from the plurality of points including a first intersection point as an intersection point of the first fitted line and the second fitted line.

9. The travel control system of claim 8, wherein the processor is configured or programmed to:
find a second intersection point as an intersection point of a straight line defining a bottom end of the first region of interest and the first fitted line in the vehicle coordinate system;
find a third intersection point as an intersection point of a straight line defining a top end of the second region of interest and the second fitted line in the vehicle coordinate system; and find the approximation curve from the first intersection point, the second intersection point and the third intersection point.

10. The travel control system of claim 9, wherein the processor is configured or programmed to:
find a fourth intersection point as an intersection point of a straight line defining a top end of the first region of interest and the first fitted line, and find a fifth intersection point as an intersection point of a straight line defining a bottom end of the second region of interest and the second fitted line; and
find the approximation curve from the first intersection point, the second intersection point, the third intersection point, the fourth intersection point and the fifth intersection point.

11. The travel control system of claim 10, wherein the processor is configured or programmed to find a Bezier curve including the fourth intersection point and the fifth intersection point as two ends thereof.

12. The travel control system of claim 11, wherein
the approximation curve in the vehicle coordinate system includes a first curved portion located on the side of the first region of interest with respect to the first intersection point and a second curved portion located on the side of the second region of interest with respect to the first intersection point; and
the controller is configured or programmed to control the travel of the work vehicle based on a deviation between an origin of the vehicle coordinate system and the second curved portion.

13. The travel control system of claim 12, wherein as seen in a plan view seen from above the ground surface on which the work vehicle travels, the origin of the vehicle coordinate system is on a rear wheel axis of the work vehicle.

14. The travel control system of claim 12, wherein the controller is configured or programmed to control the travel of the work vehicle further based on a heading deviation between a direction in which a tangent of a given point on the first curved portion extends and an orientation of the work vehicle.

15. The travel control system of claim 1, wherein the first direction is a forward direction for the work vehicle, and the second direction is a rearward direction for the work vehicle.

16. A work vehicle, comprising:
a first imager;
a second imager; and
the travel control system of claim 1.

17. A computer-implemented travel control method for a work vehicle, the travel control method causing a computer to execute: acquiring first time-series images including a first portion of a crop row or a ridge in a field from a first imager attached to a work vehicle for agriculture so as to face in a first direction;
acquiring second time-series images including a second portion of the crop row or the ridge from a second imager attached to the work vehicle so as to face in a second direction different from the first direction; and
finding a first fitted line of the first portion in a vehicle coordinate system fixed to the work vehicle, based on the first time-series images;
finding a second fitted line of the second portion in the vehicle coordinate system, based on the second time-series images; and
determining a travel path of the work vehicle based on the first fitted line and the second fitted line.
